(19) United States
(12) Patent Application Publication
(10) Pub. No.: US 2025/0310819 A1
(43) Pub. Date: Oct. 2, 2025

(54) INTER-NODE COMMUNICATION

(71) Applicant: QUALCOMM Incorporated, San Diego, CA (US)

(72) Inventors: Toru UCHINO, Zushi-shi (JP); Geetha Priya RAJENDRAN, Bangalore (IN); Prasad Reddy KADIRI, San Diego, CA (US); Bharat SHRESTHA, San Diego, CA (US); Umesh PHUYAL, San Diego, CA (US)

(21) Appl. No.: 18/623,595

(22) Filed: Apr. 1, 2024

(51) Int. Cl. H04W 28/02; H04W 28/18

(52) U.S. Cl. CPC H04W 28/0226; H04W 28/0284; H04W 28/18

(57) ABSTRACT

Various aspects of the present disclosure generally relate to wireless communication. In some aspects, a first node may receive, from a second node, configuration information associated with a configuration of the second node. The first node may provide, for at least one third node, at least a portion of the configuration information, such that the at least the portion of the configuration information is distributed to a plurality of third nodes that are associated with the second node. Numerous other aspects are described.

### INTRODUCTION

Aspects of the present disclosure generally relate to wireless communication and specifically relate to techniques, apparatuses, and methods for communication between a plurality of network nodes, such as non-terrestrial network nodes and core nodes.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed at a first node. The method may include receiving, from a second node, configuration information associated with a configuration of the second node. The method may include providing, for at least one third node, at least a portion of the configuration information, such that the at least the portion of the configuration information is distributed to a plurality of third nodes that are associated with the second node.

Some aspects described herein relate to a method of wireless communication performed by a second node. The method may include providing, to a first node, configuration information associated with a configuration of the second node, wherein at least a portion of the configuration information is provided to at least one third node via the first node and is provided for distribution to a plurality of third nodes. The method may include receiving, from one or more third nodes via the second node, a configuration update based on providing the configuration information.

Some aspects described herein relate to a method of wireless communication performed by a third node. The method may include receiving, from a first node, at least a portion of configuration information associated with a configuration of a second node, wherein the at least the portion of the configuration information is distributed to a plurality of third nodes. The method may include communicating with the first node via the second node based on the receipt of the at least the portion of the configuration information.

Some aspects described herein relate to a non-transitory computer-readable medium that stores a set of instructions for wireless communication by a first node. The set of instructions, when executed by one or more processors of the first node, may cause the first node to receive, from a second node, configuration information associated with a configuration of the second node. The set of instructions, when executed by one or more processors of the first node, may cause the first node to provide, for at least one third node, at least a portion of the configuration information, such that the at least the portion of the configuration information is distributed to a plurality of third nodes that are associated with the second node.

Some aspects described herein relate to a non-transitory computer-readable medium that stores a set of instructions for wireless communication by a second node. The set of instructions, when executed by one or more processors of the second node, may cause the second node to provide, to a first node, configuration information associated with a configuration of the second node, wherein at least a portion of the configuration information is provided to at least one third node via the first node and is provided for distribution to a plurality of third nodes. The set of instructions, when executed by one or more processors of the second node, may cause the second node to receive, from one or more third nodes via the second node, a configuration update based on providing the configuration information.

Some aspects described herein relate to a non-transitory computer-readable medium that stores a set of instructions for wireless communication by a third node. The set of instructions, when executed by one or more processors of the third node, may cause the third node to receive, from a first node, at least a portion of configuration information associated with a configuration of a second node, wherein the at least the portion of the configuration information is distributed to a plurality of third nodes. The set of instructions, when executed by one or more processors of the third node, may cause the third node to communicate with the first node via the second node based on the receipt of the at least the portion of the configuration information.

Some aspects described herein relate to a first node for wireless communication. The first node may include one or more memories and one or more processors coupled to the one or more memories. The one or more processors may be configured to cause the first node to receive, from a second node, configuration information associated with a configuration of the second node. The one or more processors may be configured to cause the first node to provide, for at least one third node, at least a portion of the configuration information, such that the at least the portion of the configuration information is distributed to a plurality of third nodes that are associated with the second node.

Some aspects described herein relate to a second node for wireless communication. The second node may include one or more memories and one or more processors coupled to the one or more memories. The one or more processors may be configured to cause the second node to provide, to a first node, configuration information associated with a configuration of the second node, wherein at least a portion of the configuration information is provided to at least one third node via the first node and is provided for distribution to a plurality of third nodes. The one or more processors may be configured to cause the second node to receive, from one or more third nodes via the second node, a configuration update based on providing the configuration information.

Some aspects described herein relate to a third node for wireless communication. The third node may include one or more memories and one or more processors coupled to the one or more memories. The one or more processors may be configured to cause the third node to receive, from a first node, at least a portion of configuration information associated with a configuration of a second node, wherein the at least the portion of the configuration information is distributed to a plurality of third nodes. The one or more processors may be configured to cause the third node to communicate with the first node via the second node based on the receipt of the at least the portion of the configuration information.

Some aspects described herein relate to an apparatus for wireless communication. The apparatus may include means for receiving, from a second node, configuration information associated with a configuration of the second node. The apparatus may include means for providing, for at least one third node, at least a portion of the configuration information, such that the at least the portion of the configuration information is distributed to a plurality of third nodes that are associated with the second node.

Some aspects described herein relate to an apparatus for wireless communication. The apparatus may include means for providing, to a first node, configuration information associated with a configuration of the second node, wherein at least a portion of the configuration information is provided to at least one third node via the first node and is provided for distribution to a plurality of third nodes. The apparatus may include means for receiving, from one or more third nodes via the second node, a configuration update based on providing the configuration information.

Some aspects described herein relate to an apparatus for wireless communication. The apparatus may include means for receiving, from a first node, at least a portion of configuration information associated with a configuration of a second node, wherein the at least the portion of the configuration information is distributed to a plurality of third nodes. The apparatus may include means for communicating with the first node via the second node based on the receipt of the at least the portion of the configuration information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node, proxy node, or core node in communication with an example UE in a wireless network in accordance with the present disclosure.

FIG. 3 is a diagram illustrating an example disaggregated base station architecture in accordance with the present disclosure.

FIGS. 4A and 4B are diagrams illustrating an example of a regenerative satellite deployment and an example of a transparent satellite deployment, respectively, in a non-terrestrial network (NTN).

FIGS. 5A and 5B are diagrams illustrating examples of network architectures for NTNs, in accordance with the present disclosure.

FIGS. 6A and 6B are diagrams illustrating an example of a proxy node, in accordance with the present disclosure.

FIGS. 7A-7C are diagrams illustrating examples associated with configuration information handling, in accordance with the present disclosure.

FIG. 8 is a diagram illustrating an example associated with configuration information handling, in accordance with the present disclosure.

FIGS. 9A and 9B are diagrams illustrating an example associated with node identification information handling, in accordance with the present disclosure.

FIG. 10 is a diagram illustrating an example associated with using a proxy node as an endpoint between nodes, in accordance with the present disclosure.

FIG. 11 is a diagram illustrating an example process performed, for example, at a first node or an apparatus of a first node, in accordance with the present disclosure.

FIG. 12 is a diagram illustrating an example process performed, for example, at a second node or an apparatus of a second node, in accordance with the present disclosure.

FIG. 13 is a diagram illustrating an example process performed, for example, at a third node or an apparatus of a third node, in accordance with the present disclosure.

FIG. 14 is a diagram of an example apparatus for wireless communication, in accordance with the present disclosure.

FIG. 15 is a diagram illustrating an example of a hardware implementation for an apparatus employing a processing system, in accordance with the present disclosure.

FIG. 16 is a diagram illustrating an example of an implementation of code and circuitry for an apparatus, in accordance with the present disclosure.

FIG. 17 is a diagram of an example apparatus for wireless communication, in accordance with the present disclosure.

FIG. 18 is a diagram illustrating an example of a hardware implementation for an apparatus employing a processing system, in accordance with the present disclosure.

FIG. 19 is a diagram illustrating an example of an implementation of code and circuitry for an apparatus, in accordance with the present disclosure.

FIG. 20 is a diagram of an example apparatus for wireless communication, in accordance with the present disclosure.

FIG. 21 is a diagram illustrating an example of a hardware implementation for an apparatus employing a processing system, in accordance with the present disclosure.

FIG. 22 is a diagram illustrating an example of an implementation of code and circuitry for an apparatus, in accordance with the present disclosure.

### DETAILED DESCRIPTION

Some communications systems may be characterized as terrestrial networks (TNs). For example, a TN-based communications system may include network nodes (e.g., base stations) deployed at ground level or on buildings. The network nodes, deployed at fixed or mobile locations at the Earth's surface may be referred to as “TN network nodes” or “TN nodes” and may provide coverage for a user equipment (UE) operating in a wide variety of indoor and outdoor locations. Further coverage enhancements may be achieved by introducing non-terrestrial networks (NTN). Such a communications system may include network nodes deployed via satellites in various different orbital shells or planes, such as a geostationary orbit, low Earth orbit (LEO), middle Earth orbit (MEO), or high Earth orbit (HEO), among other examples. In some examples, NTN communications systems may also include network nodes deployed above ground level, such as via unmanned aerial vehicles (UAVs), airplanes, high-altitude balloons, and other types of platforms, which may sometimes be referred to as “pseudo satellites”. The network nodes deployed via satellites (or other types of, for example, aerial platforms) orbiting the Earth's surface may be referred to as “NTN network nodes” or “NTN nodes”. Although some examples are described in terms of nodes deployed in fixed locations or on aerial platforms, other types of node deployments are contemplated, such as other types of ground-based platforms, other types of aerial-based platforms, other types of aquatic-based platforms, or other types of space-based platforms, among other examples.

A first type of network architecture that incorporates NTN nodes is a transparent architecture, which may also be referred to as a “bent-pipe” configuration. In a transparent architecture, a network node may be disaggregated, such that some functions of the network node are ground-based and other functions of the network node are deployed on a satellite. In the transparent architecture, the satellite-based portion of the network node acts as a repeater, repeating a signal from the ground-based portion of the network node. In one or more examples, the satellite-based portion of the network node implements frequency conversion and radio frequency amplification functions, but offloads other processing functions to the ground-based portion of the network node.

A second type of network architecture that incorporates NTN nodes is a gNB on board architecture. In the gNB on board architecture, additional (or all) functions of the network node may be deployed on a satellite. Accordingly, different satellite-based NTNs may communicate via an inter-satellite link (ISL) or the Xn (backhaul) interface. An ISL may include a radio link between satellites (e.g., without use of ground-station-based communications. Furthermore, a satellite-based NTN may communicate with a TN via an Xn interface. When using a gNB on board architecture, satellites may have control plane signaling associated with changing geographic areas of network nodes deployed thereon. In other words, rather than a network node having a fixed location and address with a repeater location changing (as occurs in a transparent architecture), the network node has a variable location and address. Accordingly, some core node functions may change to account for the gNB on board architecture. For example, an access and mobility management function (AMF) may update a tracking area (TA) list to account for a changing location of a gNB on board architecture satellite. The AMF may refer to a control plane function of a 5G core network that performs operations relating to mobility management. Although some examples are described in terms of a 5G AMF, other core nodes, functions, or types of nodes are contemplated. Proxy nodes may be introduced to provide an endpoint between other nodes within a communications network. An endpoint may refer to a routing destination for a communication. For example, proxy nodes may be introduced as routing destinations for other nodes, such as using an Internet Protocol (IP) address, user datagram protocol (UDP) port, or any other identifier or combination thereof to identify a destination. Accordingly, a network address that identifies a node may be replaced by another network address that routes to the proxy node. Alternatively, a network address that is to route to a node may be reassigned to route to a proxy node. Accordingly, the proxy node may maintain information associated with resolving which node, connected to the proxy node, is a destination for a message that is directed to the proxy node. In some examples, a proxy node may be deployed via a server or other hardware of a ground station disposed, with respect to routing, between a set of NTN nodes and an AMF.

The AMF may transmit configuration information to and/or receive configuration information from network nodes. For example, the AMF may provide a status indication message to a network node to indicate that the AMF is temporarily (or permanently) unavailable. Based on receiving the status indication, a network node may reselect to a different AMF. In another scenario, an AMF may provide an overload start message to cause a network node to reduce signaling load (temporarily until a corresponding overload stop message is provided). However, in a gNB on board scenario with moving satellites, multiple different network nodes (e.g., NTN nodes) may connect to an AMF in succession, which may cause the AMF to transmit multiple configuration information messages, such as multiple status indications or multiple overload start or stop messages. Similarly, the multiple different network nodes may have different configurations or capabilities and may transmit multiple configuration information messages to identify the different configurations or capabilities.

An uplink/downlink (UL/DL) configuration transfer procedure can be used to exchange network node configurations for self-organizing network (SON) capabilities. For example, network node configurations can be used by NTN nodes for X2 or Xn interface transport layer address (TNL) address discovery procedures. In one example of TNL address discovery procedures, a first network node detects a second network node, such as using an automatic neighbor relations (ANR) function for which a TNL address of the second network node is not known by the network node. In such an example, the first network node may use an uplink configuration transfer procedure to provide the first network node's TNL address and request that the second network node provide the second network node's TNL address via an AMF. SON capabilities, such as SON optimization and ANR functions are described in more detail with regard to 3GPP Technical Specification (TS) 28.861, version 16.0.0.

The AMF may maintain information associated with mapping network nodes to endpoints. For example, the AMF may maintain information associated with mapping TNL addresses to network nodes for routing. However, when a proxy node is deployed between an AMF and a set of NTN nodes, the set of NTN nodes may share a single endpoint address at the proxy node. In other words, when the AMF attempts to resolve a TNL address for an NTN node that is connected to the AMF via a proxy node, the AMF may resolve a TNL address for the proxy node. However, the TNL address of the proxy node may be applicable to a plurality of NTN nodes that are connected to the same proxy node. Accordingly, when a plurality of NTN nodes communicate among each other to exchange configuration information for SON optimization, the presence of many moving NTN nodes may result in messages being transmitted to many different NTN nodes to update configuration information between NTN nodes. This may result in a large amount of overhead associated with routing many messages to many different NTN nodes to update configuration information between network nodes and complexity of source node of the messages since the source node may be aware of many different target nodes. Accordingly, some nodes may be replaced with new node equipment to ensure sufficient processing capability at the source nodes.

Various aspects relate generally to inter-node communication. Some aspects more specifically relate to a proxy node managing configuration information for a group of NTN nodes communicating with an AMF or for a first group of NTN nodes communicating with to a second group of NTN nodes. In some aspects, the proxy node may receive configuration information from the AMF and may provide a plurality of messages to a plurality of NTN nodes to convey the configuration information. In some aspects, the proxy node may receive the configuration information from the AMF and may provide a message to a first NTN node, which may further provide the message to a second NTN node, which may further provide the message to a third NTN node, and onward. In some aspects, the proxy node may provide message handling, using a message threshold, to account for an overload state of an AMF. In some aspects, the proxy node may receive, from a first NTN node, configuration information for an AMF. The proxy node may provide or use the configuration information for communications with the AMF when the first NTN node is in-service (e.g., providing communication service for a configured cell or for a configured geographical area, connecting NTN gateway, or AMF). When the first NTN node is out-of-service (e.g., no longer providing communication service for the configured cell (or for a configured geographical area, connecting NTN gateway, or AMF)) and a second NTN node is in-service, the proxy node may update the configuration information based on a capability of the second NTN node. In some aspects, the proxy node may configure an NTN node with identification information to enable messaging of configuration transfer information to the NTN node. In some aspects, the proxy node may establish end point configurations with different NTN nodes and may facilitate information transfer between the different NTN nodes using the end point configurations.

Particular aspects of the subject matter described in this disclosure can be implemented to improve communication performance. In some examples, by providing a proxy node to distribute configuration information, the described techniques can be used to reduce an amount of signaling associated with an AMF providing configuration information for a set of NTN nodes, or associated with a set of NTN nodes providing capability information for an AMF. In some examples, by configuring an NTN node with identification information, the described techniques can be used to provide for configuration transfer, which can be used for SON optimization techniques. In some examples, by configuring a proxy node as a node providing an endpoint for sets of NTN nodes that are in communication with each other, the described techniques can be used to reduce signaling complexity for NTN nodes. Although some aspects are described herein in terms of NTN nodes and AMFs, those aspects and/or other aspects described herein may be applicable other types of nodes, such as access nodes or core nodes, among other examples.

Various aspects of the present disclosure are described hereinafter with reference to the accompanying drawings. However, aspects of the present disclosure may be embodied in many different forms and are not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

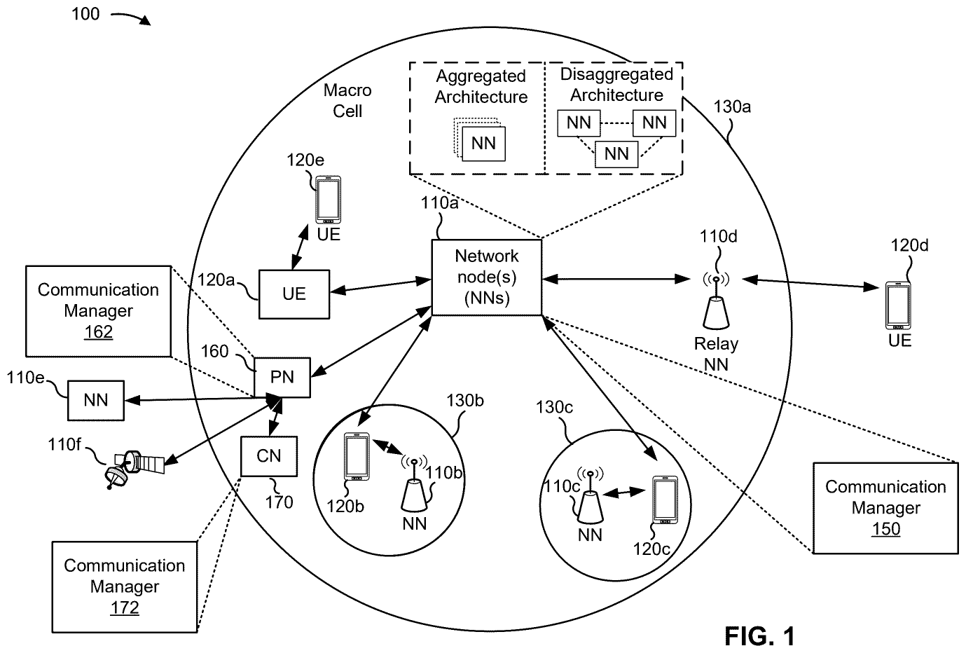

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In one or more examples, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO).

Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some examples, the network nodes 110 may be connected to a proxy node 160 and/or a core node 170. For example, a proxy node 160 may provide communication between a network node 110 (e.g., the network nodes 110e and 110f) and a core node 170 (e.g., an access and mobility management function (AMF)). Additionally, or alternatively, the proxy node 160 may provide communication between the network node 110e, the network node 110f, and/or the network node 110a. A proxy node 160 may include a function, component, or server operating in the wireless communication network 100. For example, the proxy node 160 may be co-located with a gateway device, which serves a non-terrestrial node (NTN) type of network node 110 in a gNB on board deployment, as described in more detail herein.

In some aspects, a first node (e.g., the proxy node 160) may include a communication manager 162. As described in more detail elsewhere herein, the communication manager 162 may receive, from a second node, configuration information associated with a configuration of the second node; and provide, for at least one third node, at least a portion of the configuration information, such that the at least the portion of the configuration information is distributed to a plurality of third nodes that are associated with the second node. Additionally, or alternatively, the communication manager 162 may perform one or more other operations described herein.

In some aspects, a second node (e.g., a core node 170) may include a communication manager 172. As described in more detail elsewhere herein, the communication manager 172 may provide, to a first node, configuration information associated with a configuration of the second node, wherein at least a portion of the configuration information is provided to at least one third node via the first node and is provided for distribution to a plurality of third nodes; and receive, from one or more third nodes via the second node, a configuration update based on providing the configuration information. Additionally, or alternatively, the communication manager 172 may perform one or more other operations described herein.

In some aspects, a third node (e.g., a network node 110) may include a communication manager 150. As described in more detail elsewhere herein, the communication manager 150 may receive, from a first node, at least a portion of configuration information associated with a configuration of a second node, wherein the at least the portion of the configuration information is distributed to a plurality of third nodes; and communicate with the first node via the second node based on the receipt of the at least the portion of the configuration information. Additionally, or alternatively, the communication manager 150 may perform one or more other operations described herein.

As indicated above, FIG. 1 is provided as an example. Other examples may differ from what is described with regard to FIG. 1.

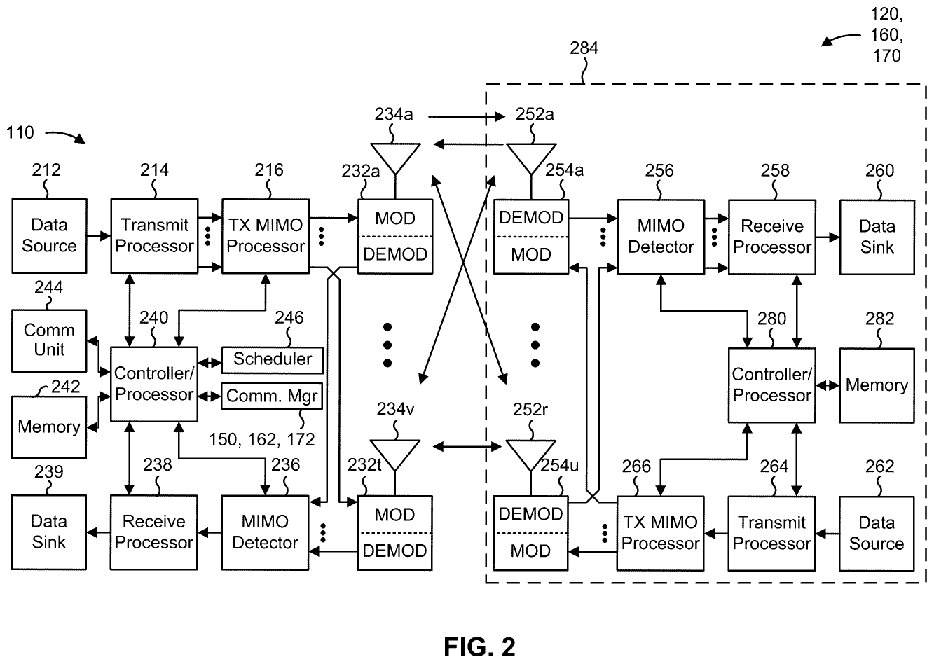

FIG. 2 is a diagram illustrating an example network node 110, proxy node 160, or core node 170 in communication with an example UE 120 in a wireless network in accordance with the present disclosure. Although some components are described, herein, in terms of the network node 110, one or more components described herein may include, be included in, or be associated with a proxy node 160 or a core node 170.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

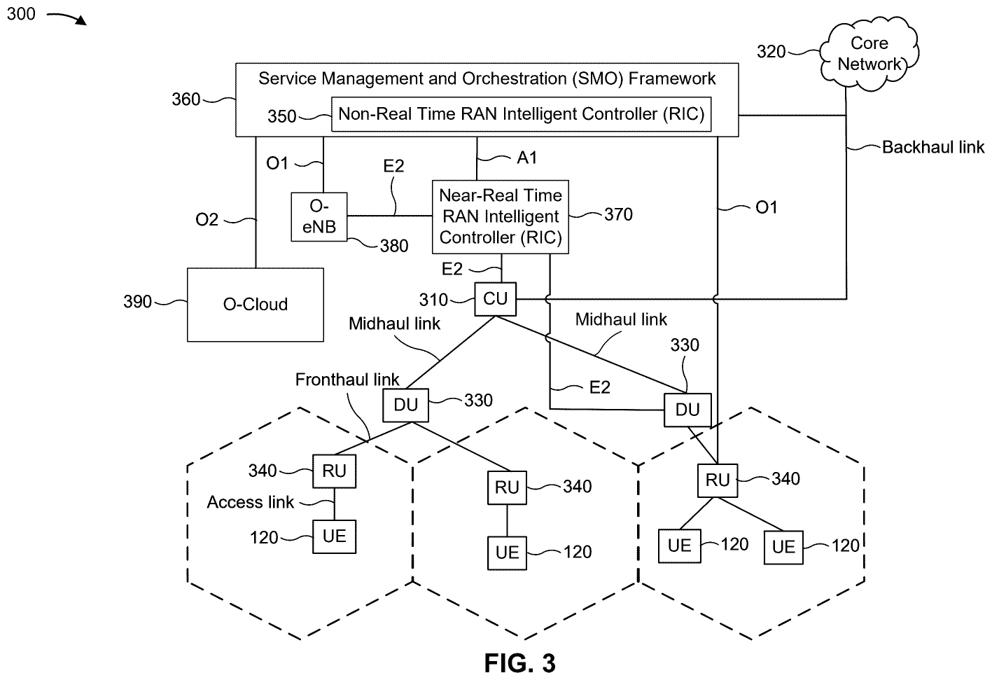

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

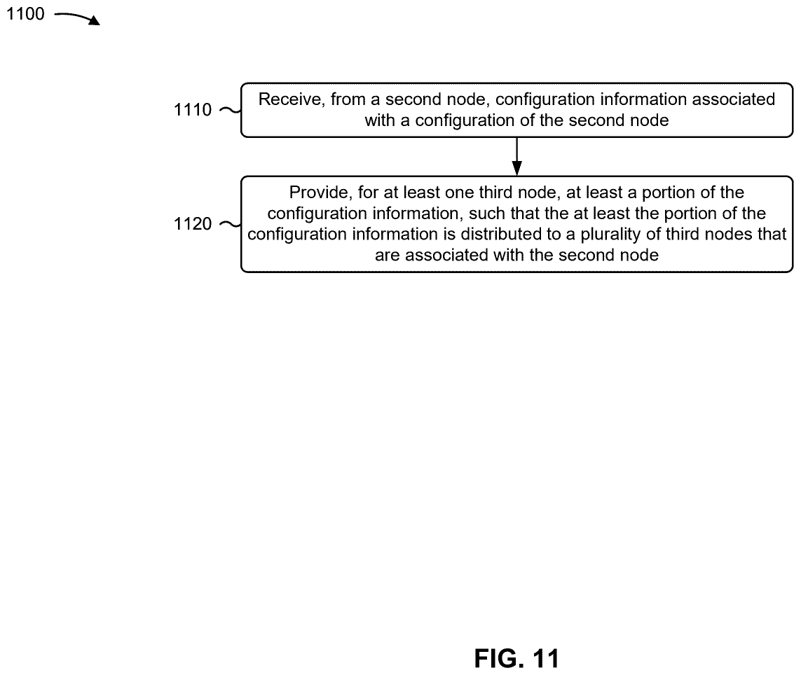

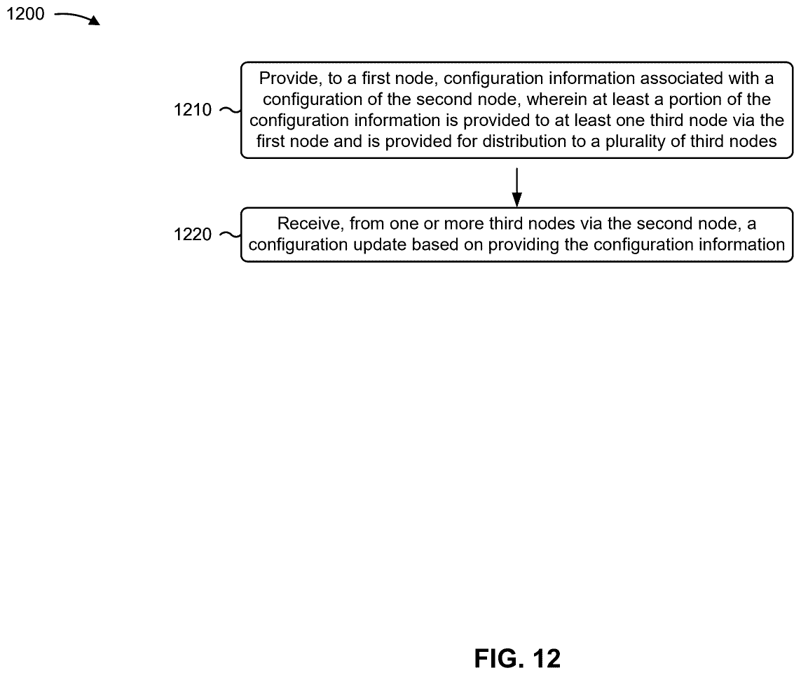

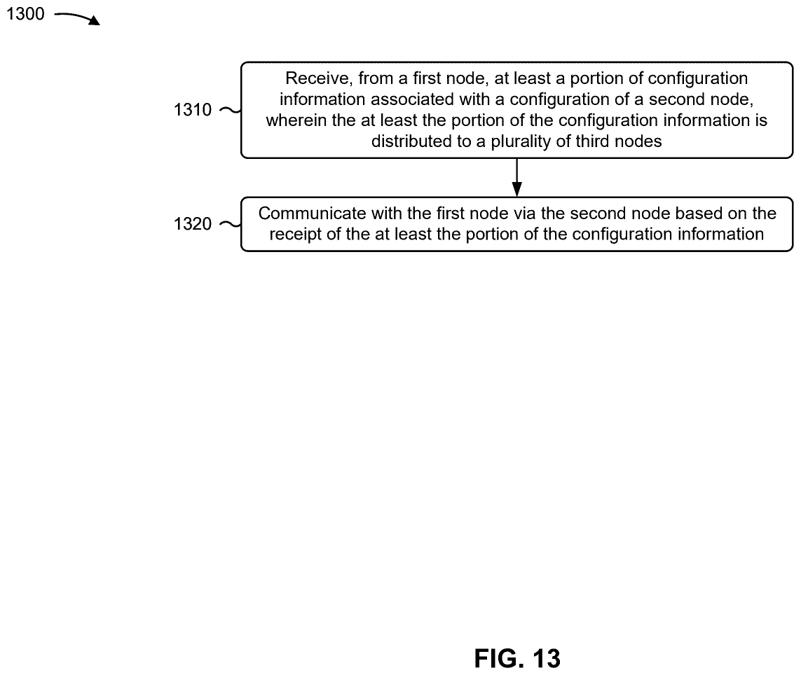

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with inter-node communication, as described in more detail elsewhere herein. For example, the controller/processor 240 of the network node 110 (or the proxy node 160 or the core node 170), the controller/processor 280 of the UE 120, any other component(s) of FIG. 2, the CU 310, the DU 330, or the RU 340 may perform or direct operations of, for example, process 1100 of FIG. 11, process 1200 of FIG. 12, process 1300 of FIG. 13, or other processes as described herein (alone or in conjunction with one or more other processors). The memory 242 may store data and program codes for the network node 110, the proxy node 160, the core node 170, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the proxy node 160, the core node 170, the UE 120, the CU 310, the DU 330, or the RU 340, may cause the one or more processors to perform process 1100 of FIG. 11, process 1200 of FIG. 12, process 1300 of FIG. 13, or other processes as described herein. In some examples, executing instructions may include running the instructions, converting the instructions, compiling the instructions, and/or interpreting the instructions, among other examples.

In some aspects, a first node (e.g., the proxy node 160) includes means for receiving, from a second node, configuration information associated with a configuration of the second node; and/or means for providing, for at least one third node, at least a portion of the configuration information, such that the at least the portion of the configuration information is distributed to a plurality of third nodes that are associated with the second node. In some aspects, the means for the first node (e.g., the proxy node 160) to perform operations described herein may include, for example, one or more of communication manager 162, transmit processor 214, TX MIMO processor 216, modem 232, antenna 234, MIMO detector 236, receive processor 238, controller/processor 240, memory 242, or scheduler 246.

In some aspects, a second node (e.g., the core node 170) includes means for providing, to a first node, configuration information associated with a configuration of the second node, wherein at least a portion of the configuration information is provided to at least one third node via the first node and is provided for distribution to a plurality of third nodes; and/or means for receiving, from one or more third nodes via the second node, a configuration update based on providing the configuration information. In some aspects, the means for the second node (e.g., the core node 170) to perform operations described herein may include, for example, one or more of communication manager 172, transmit processor 214, TX MIMO processor 216, modem 232, antenna 234, MIMO detector 236, receive processor 238, controller/processor 240, memory 242, or scheduler 246.

In some aspects, a third node (e.g., the network node 110) includes means for receiving, from a first node, at least a portion of configuration information associated with a configuration of a second node, wherein the at least the portion of the configuration information is distributed to a plurality of third nodes; and means for communicating with the first node via the second node based on the receipt of the at least the portion of the configuration information. In some aspects, the means for the third node (e.g., the network node 110) to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

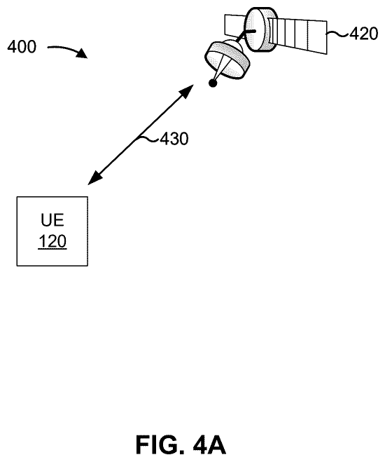

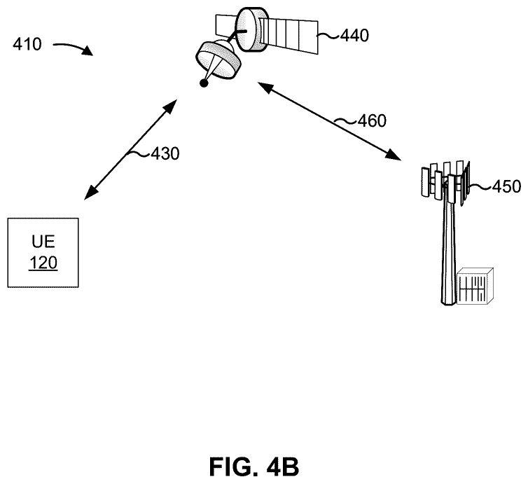

FIGS. 4A and 4B are diagrams illustrating an example 400 of a regenerative satellite deployment and an example 410 of a transparent satellite deployment, respectively, in a non-terrestrial network (NTN).

Example 400 shows a regenerative satellite deployment. In example 400, a UE 120 is served by a satellite 420 via a service link 430. For example, the satellite 420 may include a network node 110 (e.g., network node 110a) or a gNB. In some aspects, the satellite 420 may be referred to as a non-terrestrial base station, a regenerative repeater, or an on board processing repeater. In some aspects, the satellite 420 may demodulate an uplink radio frequency signal, and may modulate a baseband signal derived from the uplink radio signal to produce a downlink radio frequency transmission. The satellite 420 may transmit the downlink radio frequency signal on the service link 430. The satellite 420 may provide a cell that covers the UE 120.

FIG. 4B and example 410 show a transparent satellite deployment, which may also be referred to as a bent-pipe satellite deployment. In example 410, a UE 120 is served by a satellite 440 via the service link 430. The satellite 440 may be a transparent satellite. The satellite 440 may relay a signal received from gateway 450 via a feeder link 460. In some examples, a proxy node may be deployed within the gateway 450. The satellite may receive an uplink radio frequency transmission, and may transmit a downlink radio frequency transmission without demodulating the uplink radio frequency transmission. In some aspects, the satellite may frequency convert the uplink radio frequency transmission received on the service link 430 to a frequency of the uplink radio frequency transmission on the feeder link 460, and may amplify and/or filter the uplink radio frequency transmission. In some aspects, the UEs 120 shown in example 400 and example 410 may be associated with a Global Navigation Satellite System (GNSS) capability or a Global Positioning System (GPS) capability, though not all UEs have such capabilities. The satellite 440 may provide a cell that covers the UE 120.

The service link 430 may include a link between the satellite 440 and the UE 120, and may include one or more of an uplink or a downlink. The feeder link 460 may include a link between the satellite 440 and the gateway 450, and may include one or more of an uplink (e.g., from the UE 120 to the gateway 450) or a downlink (e.g., from the gateway 450 to the UE 120).

As indicated above, FIG. 4 is provided as an example. Other examples may differ from what is described with regard to FIG. 4.

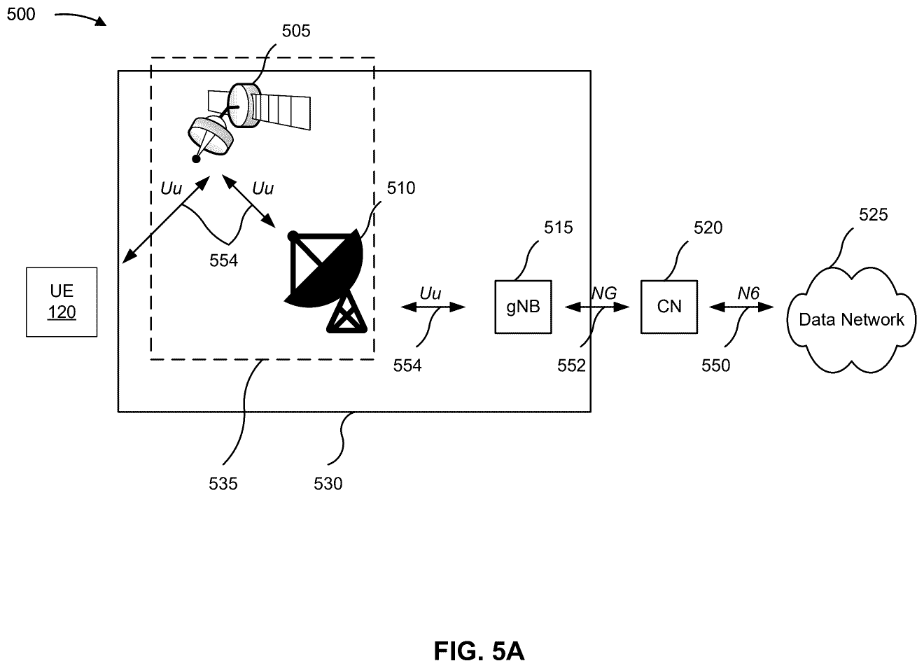

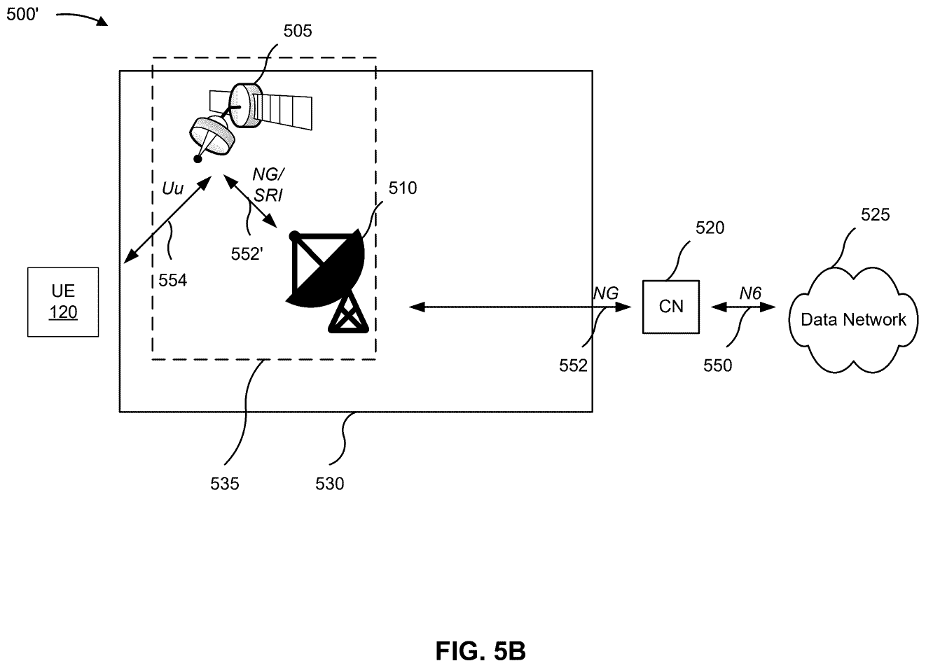

FIGS. 5A and 5B are diagrams illustrating examples 500/500′ of network architectures for NTNs, in accordance with the present disclosure. Although some examples are described herein in terms of an NTN, the examples described herein may be applicable to other network architectures, such as terrestrial network architectures.

As shown in FIG. 5A, example 500 may include a UE 120, a satellite 505, an NTN gateway 510, a gNB 515, a core node 520, and a data network 525. In the example 500, which is an example of a transparent or bent-pipe architecture, the satellite 505 and the NTN gateway 510 comprise a remote radio unit (RRU) 535.

Similarly, in the example 500, the RRU and the gNB 515 comprise a next generation (NG) radio access network (RAN) (NG-RAN) architecture 530. The data network 525 and the core node 520 may communicate via a first interface 550, such as an N6 interface. The core node 520 and the gNB 515 may communicate via a second interface 552, such as an NG interface. The gNB 515, the NTN gateway 510, the satellite 505, and the UE 120 may communicate via one or more third interfaces 554, such as one or more Uu interfaces.

Similarly, as shown in FIG. 5B, example 500′ may include the UE 120, the satellite 505, the NTN gateway 510, the core node 520, and the data network 525. In the example, 500′, which is an example of a gNB on board architecture, the satellite 505 integrates a gNB (or gNB functionality), rather than having a presence of a standalone gNB 515, as is shown in FIG. 5A. Accordingly, the NTN gateway 510 and the satellite 505 (with a gNB on board) communicate via an interface 552′, which may include an NG interface and/or a satellite radio interface (SRI).

As indicated above, FIGS. 5A and 5B are provided as examples. Other examples may differ from what is described with respect to FIGS. 5A and 5B.

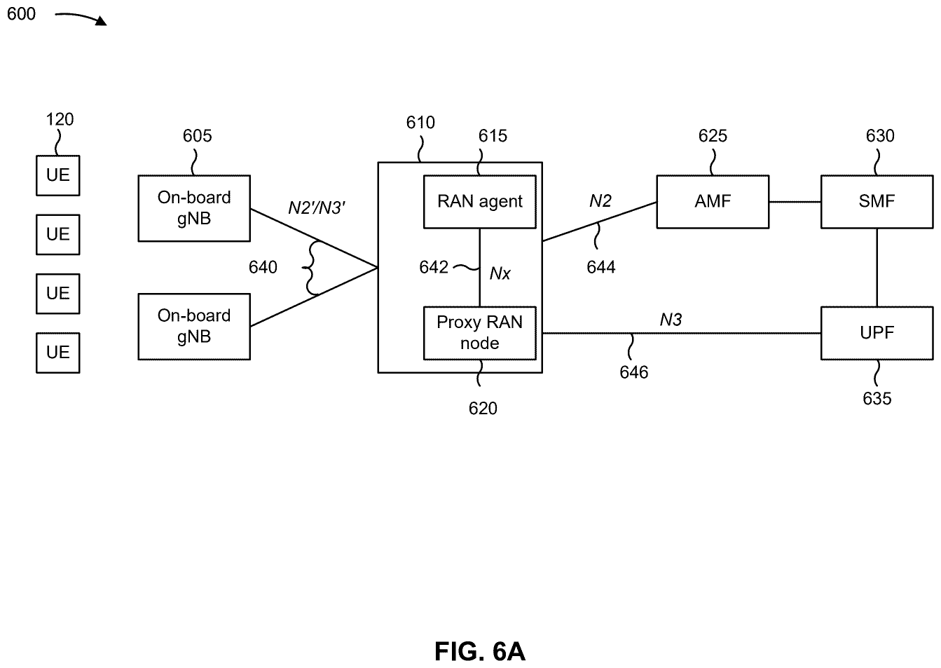

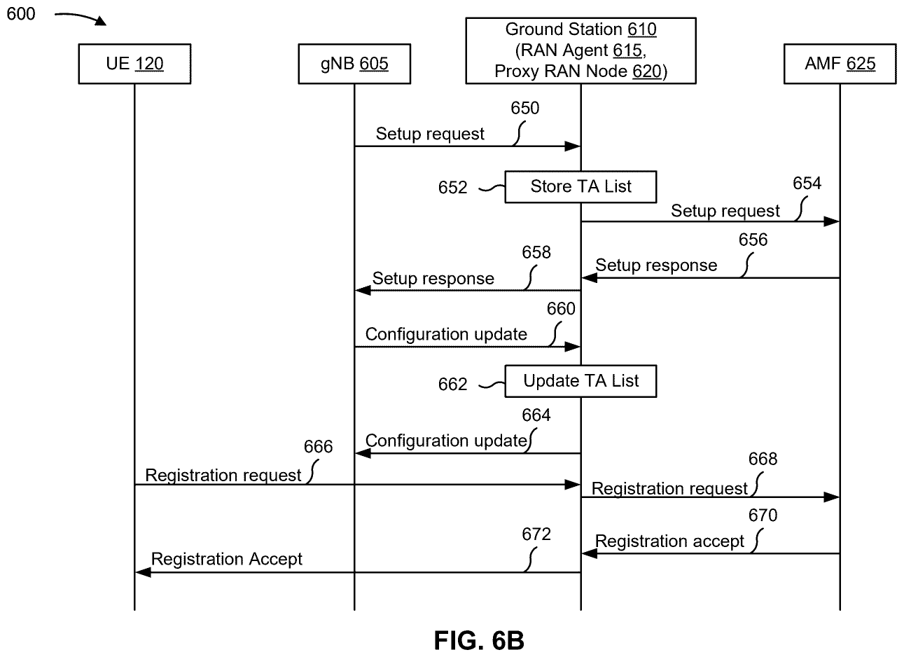

FIGS. 6A and 6B are diagrams illustrating an example 600 of a proxy node, in accordance with the present disclosure.

As shown in FIG. 6A, example 600 may include a set of UEs 120, one or more on board gNBs 605, a ground station 610 (e.g., an NTN gateway), which includes a RAN agent 615 and a proxy RAN node 620, an AMF 625, a session management function 630, and a user plane function 635. The on board gNBs 605 may communicate with the ground station 610 via one or more first interfaces 640, such as an N2′ interface or an N3′ interface. The RAN agent 615 may communicate with the proxy RAN agent 620 via a second interface 642, such as an Nx interface. The AMF 625 may communicate with the ground station 610 via a third interface 644, such as an N2 interface. The UPF 635 may communicate with the ground station 610 via a fourth interface 646, such as an N3 interface.

In some examples, a proxy node, such as the proxy node 160, may be implemented as a proxy RAN node 620 within a ground station 610. For example, in the example 600, the RAN agent 615 may process control plane signaling, such as N2 signaling and N2 message forwarding between the on board gNBs 605 and the AMF 625. In the example 600, by deploying the proxy RAN node 620 co-located with the RAN agent 615, the proxy RAN node 620 may process user plane signaling or data, such as terminating the N3 interface with the UPF 635 and establishing the N3′ connection with a serving on board gNB 605. Additional details regarding the proxy node are described in 3GPP Technical Report (TR) 23.700 version 0.3.0.

As shown in FIG. 6B, example 600 may include a signaling flow for a UE 120, an on board gNB 605 (or another type of satellite RAN node), a ground station 610 (e.g., a RAN agent 615 and a proxy RAN node 620), and an AMF 625.

As further shown in FIG. 6B, and by reference number 650, an on board gNB 605 may provide a setup request to the ground station 610. For example, the on board gNB 605 may be configured with an address for a RAN agent 615 of the ground station 610 and may use the address to transmit an NG setup message to the RAN agent 615 of the ground station 610. In some examples, the setup request may include configuration information, such as a RAN node identifier or a tracking area (TA) list associated with the on board gNB 605. As shown by reference number 652, the ground station 610 may store a TA list. For example, the RAN agent 615 of the ground station 610 may store a TA list received from the on board gNB 605 in the setup request message. In some examples, the RAN agent 615 of the ground station 610 may replace a RAN node identifier with a proxy RAN node identifier, which is allocated by the RAN agent 615. The RAN agent 615 stores a mapping between RAN node acknowledgment identifiers and proxy RAN node identifiers. In some examples, the RAN agent 615 may provide serving area information, such as the TA list, to the AMF 625.

As further shown in FIG. 6B, and by reference number 654, the AMF 625 may receive a setup request from the ground station 610. For example, the ground station 610 may provide the setup request to the AMF 625 based on receiving the setup request from the ground station 610. In some examples, the AMF 625 may receive information generated by the RAN agent 615 in connection with the setup request. For example, the AMF 625 may receive a proxy RAN node identifier (e.g., that replaces and corresponds to a RAN node identifier included in the setup request transmitted by the on board gNB 605) and a served TA list (e.g., a TA list identifying a serving area of the RAN agent 615). As shown by reference number 656, the AMF 625 may provide a setup response to the ground station 610. For example, the AMF 625 may transmit an NG setup response. As shown by reference number 658, the ground station 610 may provide the setup response to the on board gNB 605. For example, based on receiving the NG setup response from the AMF 625, the ground station 610 may transmit the NG setup response to the on board gNB 605.

As further shown in FIG. 6B, and by reference number 660, the on board gNB 605 may provide a configuration update indication to the ground station 610. For example, when the on board gNB 605 changes a supported TA list (e.g., as a result of a mobility condition) or a RAN node name, the on board gNB 605 may transmit a RAN configuration update message that includes an updated TA list supported by the on board gNB. In some examples, the ground station 610 may update a TA list, as shown by reference number 662, based on the configuration update indication, but may forgo transmitting an update to the AMF 625. For example, the ground station 610 may update a mapping of a RAN node identifier to a proxy RAN node identifier, but, based on the proxy RAN node identifier staying the same, may not need to transmit any update to the AMF 625. As shown by reference number 664, the ground station 610 may transmit an indication of the configuration update to the on board gNB 605. For example, the ground station 610 may acknowledge the RAN configuration update by transmitting an acknowledgment (ACK) message.

As further shown in FIG. 6B, and by reference number 666, the ground station 610 may receive a registration request from a UE 120. For example, when a UE 120 registers via a satellite RAN, the UE 120 may transmit a non-access stratum (NAS) transport message conveying a registration request (e.g., via the on board gNB 605) to the RAN agent 615 of the ground station 610.

As further shown in FIG. 6B, and by reference number 668, the ground station 610 may transmit the registration request to the AMF 625. For example, the RAN agent 615 may allocate a RAN UE Next Generation application protocol (NGAP) identifier (ID) in an NAS transport message with an allocated RAN UE NGAP proxy identifier. In other words, the RAN agent 615 enables a downlink message to be routed to the AMF 625 by storing a mapping between a RAN UE NGAP ID and a RAN UE NGAP proxy ID, and transmits an indication of the RAN UE proxy ID to the AMF 625. As shown by reference number 670, the AMF 625 may provide a registration accept to the ground station 610. For example, the AMF 625 may transmit an acceptance of the registration request. The RAN agent 615 may replace a RAN UE NGAP proxy ID with a RAN UE NGAP ID, using a mapping, to forward the registration accept message to the UE 120, as shown by reference number 672.

As indicated above, FIGS. 6A and 6B are provided as examples. Other examples may differ from what is described with respect to FIGS. 6A and 6B.

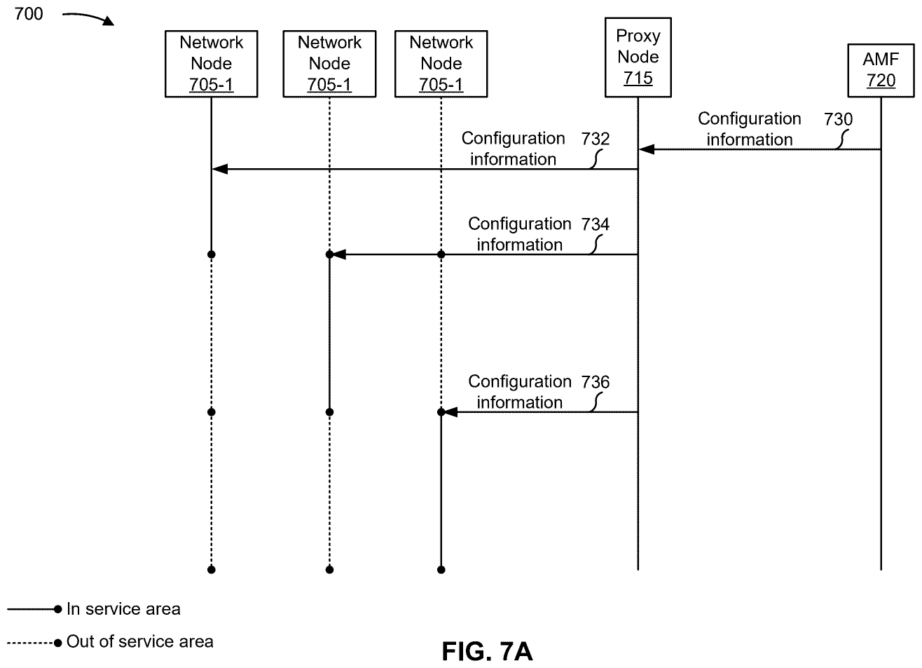

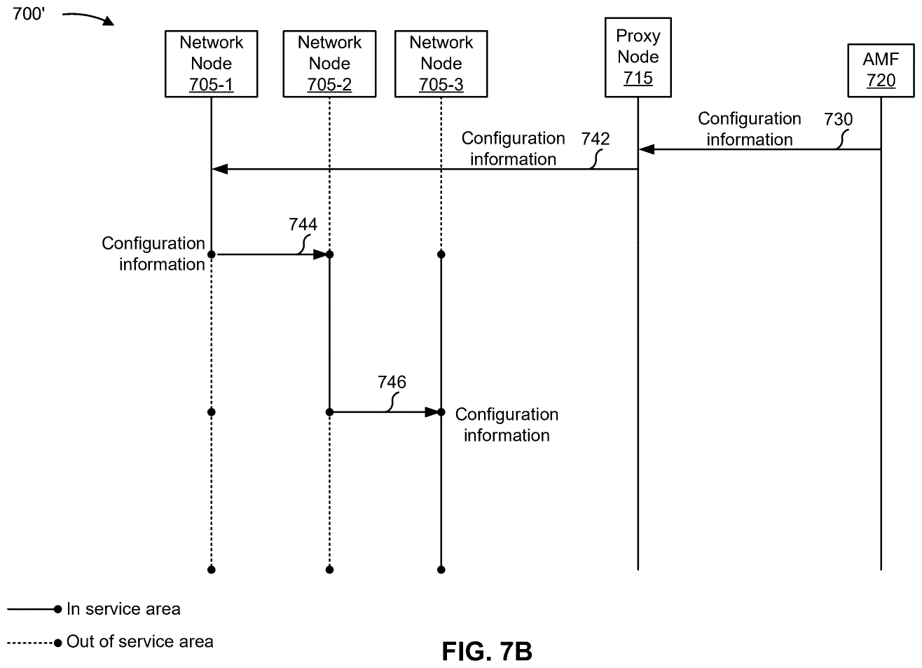

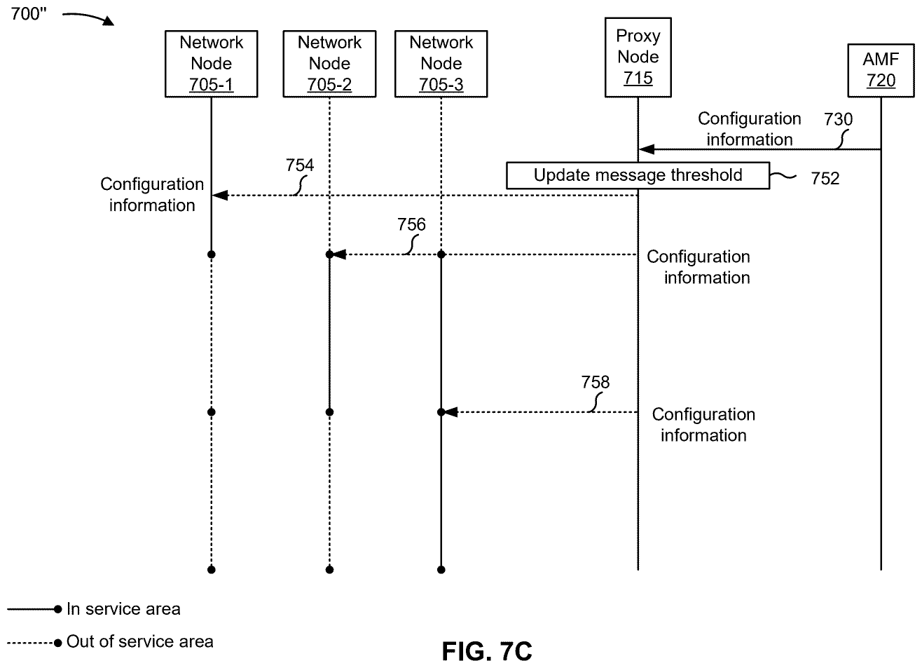

FIGS. 7A-7C are diagrams illustrating examples 700/700′/700″ associated with configuration information handling, in accordance with the present disclosure. As shown in FIGS. 7A-7C, example 700 includes communication between a set of network nodes 705 (e.g., which may correspond to the network node 110), a proxy node 715 (e.g., which may correspond to the proxy node 160), and an AMF 720 (e.g., which may correspond to the core node 170).

As further shown in FIG. 7A, and by reference number 730, the proxy node 715 may receive configuration information from the AMF 720. For example, the proxy node 715 may receive an AMF status indication message. In the example 700, the AMF 720 may transmit the AMF status indication to indicate that the AMF 720 or a globally unique AMF identifier (GUAMI) of the AMF 720 is unavailable for use, such as a result of maintenance being performed on the AMF 720. Network nodes 705 may use the AMF status indication as a trigger to perform an AMF reselection, as described in more detail with regard to 3GPP Technical Specification (TS) 23.501 version 18.4.0, section 9.2.6.10. Additionally, or alternatively, the proxy node 715 may receive an overload stop or start message. The overload stop or start message may indicate, to an NG-RAN node, such as a network node 750, an instruction to reduce a signaling load toward the AMF 720 (or resume a non-reduced signaling load), as described in more detail with regard to 3GPP TS 23.501 version 18.4.0, section 9.2.6.14 and 9.2.6.15.

As further shown in FIG. 7A, and by reference number 732, the proxy node 715 may provide at least a portion of the configuration information to the network node 705-1. For example, the proxy node 715 may transmit or forward the configuration information (or a portion thereof), received from the AMF 720, to the network node 705-1. In some aspects, the proxy node 715 may provide a content of an AMF status indication message, an overload stop message, or an overload start message to the network node 705-1, as described above.

In some aspects, as shown by reference number 732, the proxy node 715 transmits the configuration information (or the portion thereof) when the network node 705-1 is in a service area. When the network node 705-2 enters a service area (and the network node 705-1 is out of the service area), the proxy node 715 transmits the configuration information (or the portion thereof) to the network node 705-2, as shown by reference number 734. Similarly, when the network node 705-3 enters a service area (and the network node 705-2 is out of the service area), the proxy node 715 transmits the configuration information (or the portion thereof) to the network node 705-3, as shown by reference number 736.

As shown in FIG. 7B, and in example 700′, rather than transmitting a set of direct or unicast messages to the network nodes 705, individually, the proxy node 715 may transmit a single message to a single network node 705 to cause the configuration information to be distributed or propagated to the set of network nodes 705. For example, as shown by reference number 742, when the network node 705-1 is in a service area, the proxy node 715 transmits configuration information to the network node 705-1. When the network node 705-1 is out of the service area and the network node 705-2 is in the service area, the network node 705-1 provides or transmits the configuration information onward to the network node 705-2, as shown by reference number 744. Similarly, when the network node 705-2 is out of the service area and the network node 705-3 is in the service area, the network node 705-2 provides or transmits the configuration information onward to the network node 705-3, as shown by reference number 746. In another example, the AMF 720 may provide the configuration information (e.g., AMF information) for the network node 705-1 (e.g., not via the proxy node 715) and the network node 705-1 may distribute the configuration information onward to the network node 705-2, which may distribute the configuration information onward to the network node 705-3.

As shown in FIG. 7C, and in example 700″, the proxy node 715 may update a message threshold in connection with receiving the configuration information. For example, proxy node 715 may update a message threshold of a quantity of messages sent to the AMF 720, as shown by reference number 752. In this example, the proxy node 715 may optionally transmit state information to the set of network nodes 705. For example, the proxy node 715 may transmit state information (e.g., at least a portion of the configuration information received from the AMF 720) to the network node 705-1 via a first message, as shown by reference number 754, to the network node 705-2 via a second message, as shown by reference number 756, and to the network node 705-3 via a third message, as shown by reference number 758. In another example, the proxy node 715 may transmit the state information to the network node 705-1 via the first message, and the network node 705-1 may transmit the state information onward to the network node 705-2 (which may transmit the state information onward to the network node 705-3, as described herein).

In some aspects, the proxy node 715 may update the message threshold on a per unit basis. For example, the proxy node 715 may update the message threshold on a per gNB basis (e.g., per network node 705), a per endpoint basis, a per feeder link basis, a per message type basis, a per AMF basis, or any combination thereof. In some aspects, the threshold may be based on one or more priorities. For example, the proxy node 715 may configure the message threshold for a network node 705 based on a prioritization of the network node 705 relative to other network nodes 705, other endpoints, other services, or another characteristic. In some aspects, the proxy node 715 may configure the message threshold in accordance with a pre-configuration from an operations and management (OAM) device, a core node, an information node, a server, or another type of control device for the proxy node 715. In some aspects, the proxy node 715 may discard messages based on the message threshold. For example, when the proxy node 715 updates the message threshold, the proxy node 715 may determine whether a quantity of messages received (e.g., within a configured period of time) exceeds the message threshold, and may drop (e.g., suspend) or delay (e.g., to a buffer) any excess messages to avoid overloading the AMF 720. Additionally, or alternatively, the proxy node 715 may determine an action to perform on excess messages (e.g., dropping, delaying, or providing to the AMF 720) based on a prioritization or a validation time of the messages.

In some aspects, the proxy node 715 may transmit the configuration information (or at least a portion of the configuration information) in accordance with one or more timing criteria. For example, the proxy node 715 may transmit configuration information to the network node 705-1 after a threshold amount of time has elapsed from receiving the configuration information from the AMF 720. Additionally, or alternatively, the proxy node 715 may transmit the configuration information to the network node 705-1 based on receiving a request from the network node 705-1. For example, a network node 705 may transmit a request for AMF status information (e.g., when the network node 705 is to transact with an AMF or is in service) and may receive the configuration information (or at least a portion of the configuration information) as a response. A network node 705 may be in service, in an NTN context, when the network node 705 has moved to a position where the network node 705 provides service for a configured cell, for a configured geographical area, for connecting to NTN gateway, or for connecting to an AMF. When the network node 705 moves to another position, the network node 705 may transfer to being out-of-service (with respect to the configured cell or the configured geographical area) and another network node 705 may transfer to being in-service (with respect to the configured cell or the configured geographical area). Additionally, or alternatively, the proxy node 715 may transmit the configuration information based on a service status of a network node 705. For example, as described above, when a network node 705 enters a service area, the network node 705 may update a configuration (e.g., a public land mobile number (PLMN), a tracking area, a cell, or a beam) and the proxy node 715 may provide AMF configuration information based on the update to the configuration of the network node 705. Additionally, or alternatively, the proxy node 715 may determine that a feeder link is available, an NG interface is available, a gNB state has changed (e.g., the network node 705 has activated or resumed service) and may transmit AMF configuration information for the network node 705. Additionally, or alternatively, the proxy node 715 may determine that an update has occurred to the AMF status and may transmit the configuration information to identify the update to the AMF status.

In some aspects, the proxy node 715 may include a configured set of fields, values, or parameters in the configuration information (or the at least the portion of the configuration information) that is provided for and/or transmitted to the set of network nodes 705. For example, the proxy node 715 may include an AMF identity parameter (e.g., that is used by the AMF 720 or that is used by the proxy node 715 and maps to a corresponding AMF identity parameter used by the AMF 720), an endpoint identity parameter, or a feeder link identity parameter. Additionally, or alternatively, the proxy node 715 may include AMF overload information or AMF availability information. In this example, the proxy node 715 may alter the AMF overload information or AMF availability information received from the AMF 720 before providing the AMF overload information or the AMF availability information for the set of network nodes 705. For example, the proxy node 715 may account for an overload state of the proxy node 715 to adjust the overload state of the AMF 720. In other words, the AMF 720 may restrict messages to a first level to account for overload at the AMF 720, but the proxy node 715 may restrict messages to a second, lower level to account for overload at the proxy node 715 as well.

In some aspects, the proxy node 715 may include validity time information in the configuration information provided for the set of network nodes 705. For example, the proxy node 715 may indicate that a network node 705 is to consider the configuration information valid for a configured period of time. In this example, after the configured period of time has elapsed, the proxy node 715 may transmit a new configuration information message to the network node 705. In some aspects, the proxy node 715 may transmit the new configuration information message based on receiving a request for a new configuration information message from the network node 705.

In some aspects, the set of network nodes 705 may perform one or more response actions based on receiving the configuration information. For example, when a network node 705 receives the configuration information (or a portion thereof), the network node 705 may disconnect or suspend a connection with the AMF 720 and may discard the received configuration information (or may retain the received configuration information to use after reconnecting or resuming the connection). Whether the network node 705 discards or retains the received configuration information may be based on a received indication from the AMF 720 or the proxy node 715. When the network node 705 retains the received configuration information, the network node 705 may transmit signaling to the AMF 720 (which may include the received configuration information), via the proxy node 715, to instruct the AMF 720 to transmit, to the network node 705, a status change indication when the AMF 720 has a change of status.

In some aspects, the proxy node 715 may perform a response action for the network nodes 705. For example, the network nodes 705 may not need to reselect from the AMF 720 based on AMF status information, as the network nodes 705 are connected to the proxy node 715 rather than directly to the AMF 720. Instead, the proxy node 715 may reselect (e.g., from the AMF 720 to another AMF), which may effectuate a reselection on behalf of the network nodes 705 without each network node 705 having to perform a separate reselection. While the proxy node 715 is reselecting between AMFs, the proxy node 715 or the network nodes 705 may suspend providing messages (e.g., from the network node 705 to the proxy node 715 and from the proxy node 715 to the AMF 720). For example, the proxy node 715 may indicate the initiation of the reselection to the network nodes 705, which may cause the network nodes 705 to halt transmission of messages to the proxy node 715 and toward the AMF 720. In this example, the indication from the proxy node 715 may include information identifying an identity of the AMF 720, an identity of a new AMF, an identity of the proxy node 715, an identity of an endpoint, a request to adjust a quantity of messages being transmitted, or a validity time of the indication, among other examples.

As indicated above, FIGS. 7A-7C are provided as example. Other examples may differ from what is described with respect to FIGS. 7A-7C.

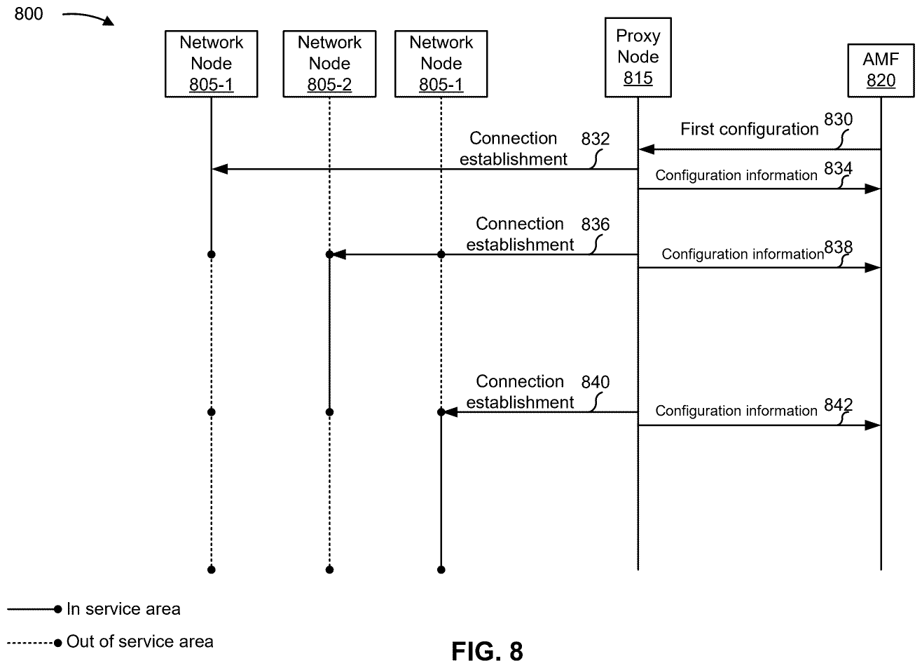

FIG. 8 is a diagram illustrating an example 800 associated with configuration information handling, in accordance with the present disclosure. As shown in FIG. 8, example 800 includes communication between a set of network nodes 805 (e.g., which may correspond to the network node 110), a proxy node 815 (e.g., which may correspond to the proxy node 160), and an AMF 820 (e.g., which may correspond to the core node 170).

As further shown in FIG. 8, and by reference number 830, the proxy node 815 may provide first configuration information to the AMF 820. For example, the proxy node 815 may provide RAN configuration information to the AMF 820. In some aspects, the proxy node 815 may establish a reference configuration, a default configuration, or a dummy configuration with the AMF 820 (e.g., before establishing a connection with a network node 805). For example, the proxy node 815 may not be ready for communication with a UE and may indicate a configured status, such as a status of not being available, a status of being fully overloaded, a status of starting up, or another type of status not indicating information to communicate with a UE (e.g., not indicating a TA or cell information).

As further shown in FIG. 8, and by reference number 832, the proxy node 815 may connect with the network node 805-1. For example, the proxy node 815 may establish or resume a connection with the network node 805-1. In this example, the proxy node 815 may update the first configuration information based on a configuration of the network node 805-1. Accordingly, as shown by reference number 834, the proxy node 815 may transmit configuration information (e.g., a second RAN configuration or a configuration update message) to the AMF 820. For example, based on detecting a change to a currently stored (default) configuration at the proxy node 815, the proxy node 815 may transmit a configuration update to indicate a new configuration of the network node 805-1.

Similarly, when the proxy node 815 disconnects from the network node 805-1 and establishes a connection or resumes a connection with the network node 805-2, as shown by reference number 836, the proxy node 815 may determine whether the network node 805-2 is associated with a RAN configuration that is different from a currently stored RAN configuration (e.g., of the network node 805-1). When the RAN configuration of the network node 805-2 differs from the RAN configuration of the network node 805-1, the proxy node 815 may transmit a content of a configuration update message to the AMF 820, as shown by reference number 838. Similarly, when the proxy node 815 disconnects from the network node 805-2 and establishes a connection or resumes a connection with the network node 805-3, as shown by reference number 840, the proxy node 815 may determine whether the network node 805-3 is associated with a RAN configuration that is different from a currently stored RAN configuration (e.g., of the network node 805-2). When the RAN configuration of the network node 805-3 differs from the RAN configuration of the network node 805-2, the proxy node 815 may transmit a configuration update message to the AMF 820, as shown by reference number 842.

In some aspects, the proxy node 815 may transmit time information with the RAN configuration information or the RAN configuration update message. For example, the proxy node 815 may transmit information indicating an amount of time for which the RAN configuration information or RAN configuration update message is valid. The time information may include a reference time and a duration, an absolute start time and an absolute end time, or other information associated with indicating a validity time for the RAN configuration information. In this example, when the configured amount of time expires, the proxy node 815 may transmit a new RAN configuration message or a RAN configuration update message to provide new or updated RAN configuration information. Additionally, or alternatively, the AMF 820 may request the new or updated RAN configuration information when the configured amount of time expires. In some aspects, the AMF 820 may store the RAN configuration information (and/or validity time information thereof) in another node, such as an information node or a server. In such aspects, the AMF 820 may request and receive the configuration information (and/or the validity time information thereof) from the other node when triggered to use the configuration information.

In some aspects, the RAN configuration information may be associated with an index value. For example, the proxy node 815 and the AMF 820 may associate a set of index values with a set of possible RAN configurations. In this example, when the proxy node 815 provides RAN configuration information, the proxy node 815 provides an index value that the AMF 820 maps to a corresponding RAN configuration.

Similarly, when the proxy node 815 detects a change to a RAN configuration of a network node 805, the proxy node 815 may transmit a RAN configuration update with a new RAN configuration index. Additionally, or alternatively, when the change to the RAN configuration results in a new type of RAN configuration, the proxy node 815 may assign a new index value to the new type of RAN configuration and may update the AMF 820 with a new mapping of the new index value to the new type of RAN configuration. In some aspects, the AMF 820 may query the proxy node 815 to receive information associated with a selected index value (or all index values).

As further shown in FIG. 8, and by reference number 834, the proxy node 815 may transmit configuration information to the AMF 820.

As indicated above, FIG. 8 is provided as an example. Other examples may differ from what is described with respect to FIG. 8.

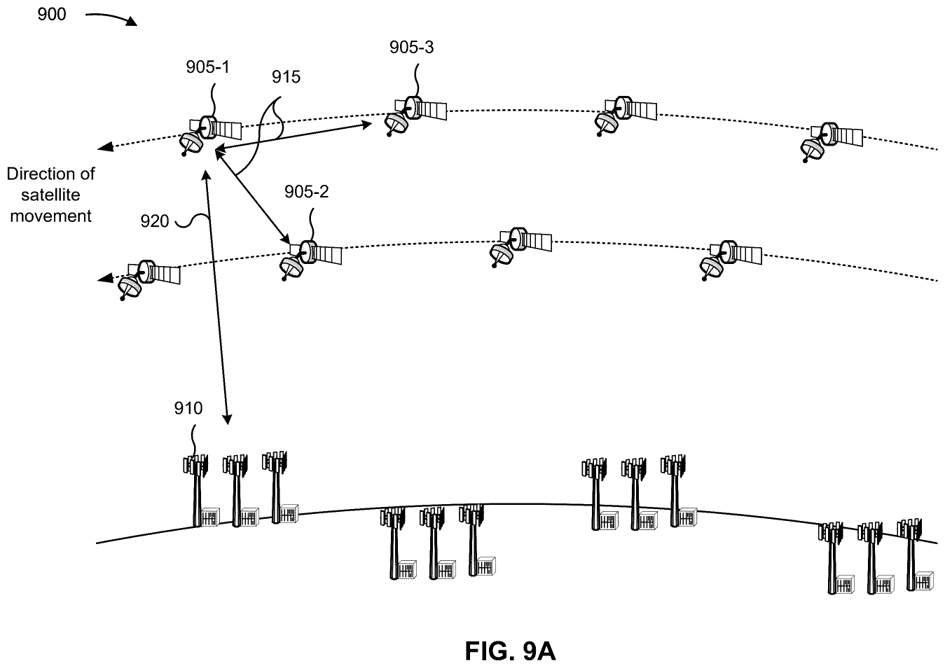

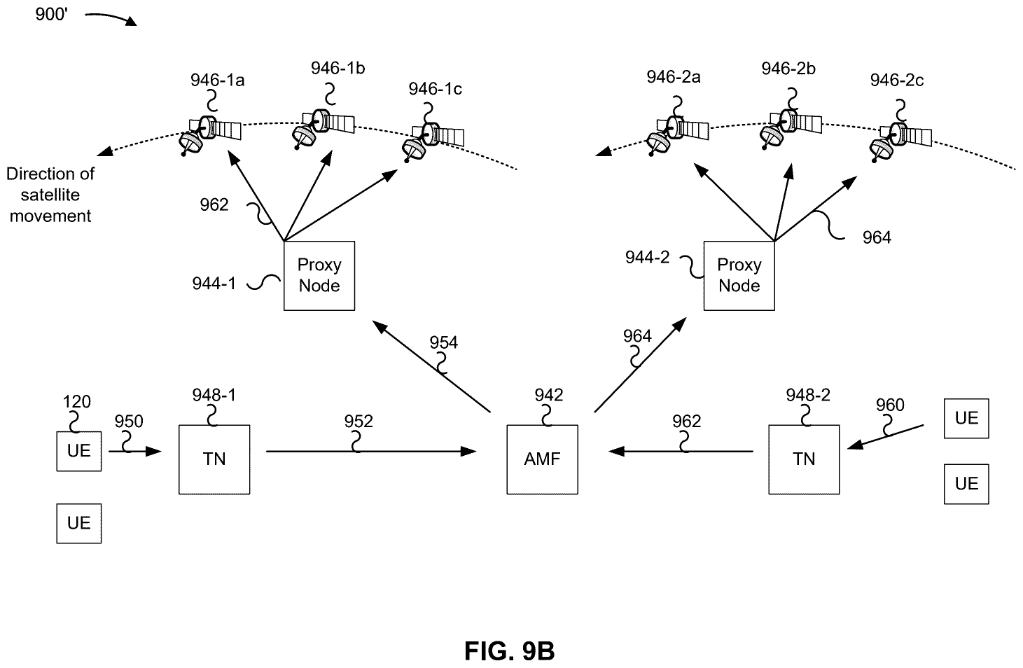

FIGS. 9A and 9B are diagrams illustrating examples 900/900′ associated with node identification information handling, in accordance with the present disclosure.

As shown in FIG. 9A, example 900 includes a first set of network nodes 905 (e.g., which may correspond to network nodes 110) and a second set of network nodes 910 (e.g., which may correspond to network nodes 110). In some examples, the first set of network nodes 905 may include NTN gNB on board nodes and the second set of network nodes 910 may include a set of terrestrial nodes (TNs). As shown in FIG. 9A, the first set of network nodes 905 may include NTNs in different orbital shells/planes (e.g., network nodes 905-1 and 905-3 are in a first orbital shell/plane and network node 905-2 is in a second orbital shell/plane). Although some aspects are described in terms of NTNs and TNs, those aspects and/or other aspects described herein may be applicable to other types of network nodes.

As further shown in FIG. 9A, configuration transfer procedures can be characterized by a (non-exhaustive) set of interactions. For example, as shown by reference number 915, a first configuration transfer procedure can occur between network nodes 905 in the same or different orbital shells/planes. As shown, network nodes 905-1 and 905-3 are in a first orbital shell/plane and network node 905-2 is in a second orbital shell/plane. For example, the network node 905-1 may transfer configuration information to the network node 905-2 in a different orbital shell/plane. Additionally, or alternatively, the network node 905-1 may transfer configuration information to the network node 905-3 in a same orbital shell/plane. In contrast, as shown by reference number 920, a second configuration transfer procedure can occur between a network node 905-1 and a network node 910. For example, the network node 905-1 may transfer configuration information to a network node 910.

As shown in FIG. 9B, example 900′ includes an AMF 942 (e.g., which may correspond to a core node 170), a set of proxy nodes 944 (e.g., which may correspond to one or more proxy nodes 160), a set of NTN nodes 946 (e.g., which may correspond to network nodes 110), a set of TN nodes 948 (e.g., which may correspond to network nodes 110), and a set of UEs 120.

As further shown in FIG. 9B, for configuration transfer, the AMF 942 maintains information on mapping of an identity of a network node (e.g., an NTN node 946-1a, 946-1b, etc.) and an endpoint. In some legacy architectures, there is a one-to-one mapping of gNB identities to endpoints, such as NTN nodes 946-1a, 946-1b, etc. or TNs 948-1 or 948-2, among other examples. However, in some proxy node architectures, such as in example 900′, as shown, a plurality of network nodes may share the same proxy node as an endpoint. In other words, there is a one-to-one mapping of gNB identities to proxy nodes (e.g., proxy node 944-1 or proxy node 944-2), but each proxy node services a plurality of NTN nodes (e.g., proxy node 944-1 serves NTN node 946-1a, 946-1b, and 946-1c). For example, as shown, the NTN nodes 946-1a through 946-1c share the proxy node 944-1 as an endpoint. Similarly, the NTN nodes 946-2a through 946-2c share the proxy node 944-2 as an endpoint. Accordingly, as shown by reference number 950, a UE 120 may report a gNB identity to the TN node 948-1, which may transmit an uplink configuration transfer message to the AMF 942, as shown by reference number 952. The AMF 942 may direct the contents of the uplink configuration transfer message to the proxy node 944-1 based on the gNB identity provided by the UE, as shown by reference number 954. In other words, the gNB identity provided by the UE identifies the proxy node 944-1, rather than the NTN node 946-1a, which is the target for the uplink configuration transfer message. However, as described above, the NTN nodes 946-1a through 946-1c share the same gNB identity. Similarly, as shown by reference number 960, a UE 120 may report a gNB identity to the TN node 948-2, which may transmit an uplink configuration transfer message to the AMF 942, as shown by reference number 962. The AMF 942 may direct the contents of the uplink configuration transfer message to the proxy node 944-2 based on the gNB identity provided by the UE 120, as shown by reference number 964. However, as described above, the NTN nodes 946-2a through 946-2c share the same gNB identity.

As shown by reference numbers 962 and 964, the proxy nodes 944-1 and 944-2, respectively, may forward the configuration transfer message to the NTN nodes 946-1a and 946-2c, respectively. In some aspects, the NTN nodes 946 may receive the configuration transfer messages based on gNB identity information. In some aspects, the NTN nodes 946 may be configured with gNB identity information. For example, the NTN nodes 946 may receive gNB identity information associated with the AMF 942, the proxy nodes 944, an endpoint, a feeder link, a geographical area, a preconfigured zone, a TA, a cell, a beam, or a time. In this example, the NTN nodes 946 may receive the gNB identity information from an OAM, a core node, an information node, a server, another NTN node 946, the proxy node 944, or the AMF 942, among other examples. In some aspects, the NTN nodes 946 may receive the gNB identity information based on establishing a connection (e.g., with the AMF 942 or a proxy node 944). Additionally, or alternatively, the NTN nodes 946 may receive the gNB identity information from other network nodes. For example, a first NTN node 946 may indicate suggested gNB identifiers for other NTN nodes 946 based on detecting the other NTN nodes 946 coming in to a service area. Additionally, or alternatively, the NTN nodes 946 may use a default or previously configured gNB identifier. Based on the provided gNB identity information, the NTN nodes 946 may determine which gNB identifier to use or may self-select a gNB identifier to use to resolve message endpoints when sharing a proxy node as an endpoint.

As indicated above, FIGS. 9A and 9B is provided as an example. Other examples may differ from what is described with respect to FIGS. 9A and 9B.

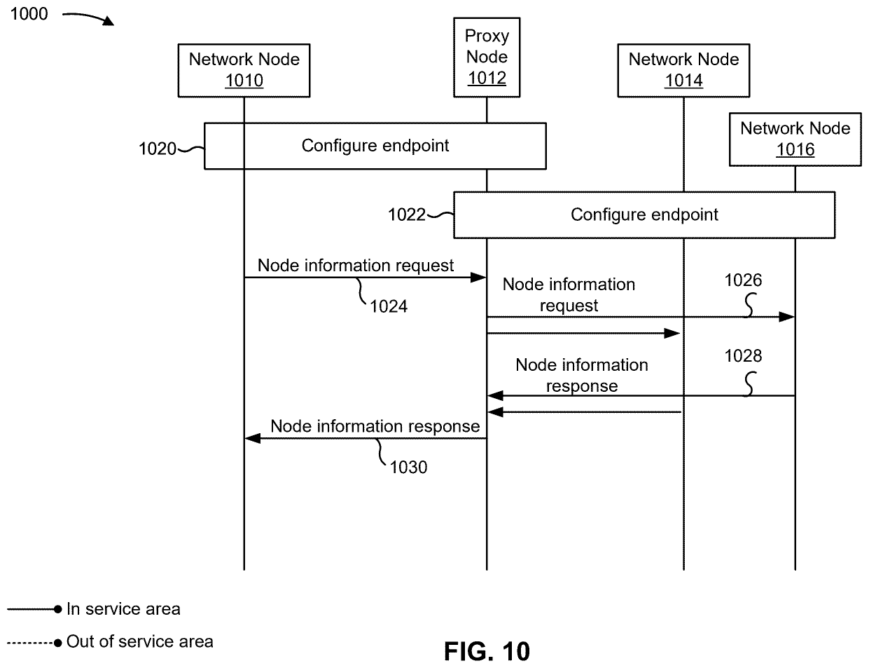

FIG. 10 is a diagram illustrating an example 1000 of using a proxy node as an endpoint between nodes, in accordance with the present disclosure. As shown in FIG. 10, example 1000 includes communication between a first network node 1010, a proxy node 1012, a second network node 1014, and a third network node 1016. In the example 1000, the network nodes 1010, 1014, and 1016 may exchange information via an Xn interface, such as state information, configuration update information, or a request for a state change. For gNB on board deployments, among other examples, network nodes may propagate received information to other peer network nodes. However, the peer network nodes may serve different geographical areas at different times. Additionally, a cell or beam of an NTN network node may overlap with many other cells or beams of a TN network node. Accordingly, the proxy node 1012 may be provided as an intermediate endpoint between network nodes.

As further shown in FIG. 10, and by reference number 1020, the first network node 1010 and the proxy node 1012 may configure an endpoint. For example, the first network node 1010 and the proxy node 1012 may exchange endpoint information. In this example, the proxy node 1012 may provide an endpoint address with which the first network node 1010 can communicate with the second network node 1014 and/or the third network node 1016, which may be aggregated as part of a gNB group or an endpoint address group.

As further shown in FIG. 10, and by reference number 1022, the second network node 1014, the third network node 1016, and the proxy node 1012 may configure an endpoint. For example, the second network node 1014 and/or the third network node 1016 may exchange endpoint information with the proxy node 1012. In this example, the proxy node 1012 may provide an endpoint address with which the second network node 1014 and/or the third network node 1016 can communicate with the first network node 1010.

As further shown in FIG. 10, and by reference number 1024, the proxy node 1012 may receive a node information request from the first network node 1010. For example, the first network node 1010 may transmit a RAN node information message or a request message to the proxy node 1012. In this example, the first network node 1010 may include a target gNB list or an endpoint identifier for a gNB group. Accordingly, the proxy node 1012 may resolve the target gNB list or the endpoint identifier for the gNB group as indicating the second network node 1014 and/or the third network node 1016.

As further shown in FIG. 10, and by reference number 1026, the proxy node 1012 may provide the node information request to the second network node 1014 and/or the third network node 1016. For example, the proxy node 1012 may transmit a first node information request to the second network node 1014 and a second node information request to the third network node 1016. In another example, the proxy node 1012 may transmit a set of node information update messages.

As further shown in FIG. 10, and by reference number 1028, the proxy node 1012 may receive a node information response from the second network node 1014 and/or the third network node 1016. For example, the proxy node 1012 may receive RAN node information from the second network node 1014 and/or the third network node 1016. In another example, the proxy node 1012 acknowledgment acknowledgement message indicating receipt (by the second network node 1014 and/or the third network node 1016) of a node information update message.

As further shown in FIG. 10, and by reference number 1030, the proxy node 1012 may provide the node information response for the first network node 1010. For example, the proxy node 1012 may provide information identifying a response to the request for RAN node information. Additionally, or alternatively, the proxy node 1012 may provide an acknowledgement of provided RAN node information.

As indicated above, FIG. 10 is provided as an example. Other examples may differ from what is described with respect to FIG. 10.

FIG. 11 is a diagram illustrating an example process 1100 performed, for example, at a first node or an apparatus of a first node, in accordance with the present disclosure. Example process 1100 is an example where the apparatus or the first node (e.g., the proxy node 160, the proxy node 715, the proxy node 815, the proxy nodes 944, or the proxy node 1012) performs operations associated with inter-node communication.

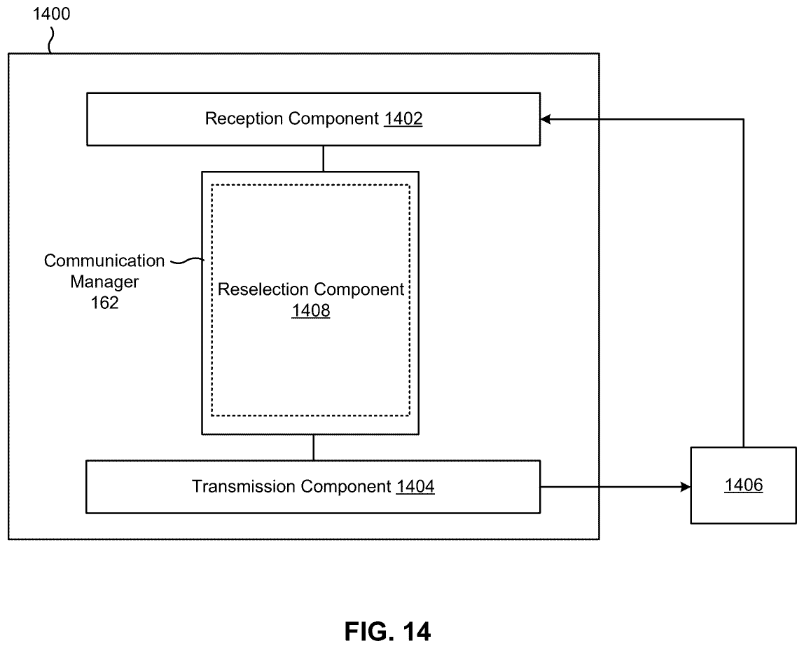

As shown in FIG. 11, in some aspects, process 1100 may include receiving, from a second node, configuration information associated with a configuration of the second node (block 1110). For example, the first node (e.g., using communication manager 162 and/or reception component 1402, depicted in FIG. 14) may receive, from a second node, configuration information associated with a configuration of the second node, as described above.

As further shown in FIG. 11, in some aspects, process 1100 may include providing, for at least one third node, at least a portion of the configuration information, such that the at least the portion of the configuration information is distributed to a plurality of third nodes that are associated with the second node (block 1120). For example, the first node (e.g., using communication manager 162 and/or transmission component 1404, depicted in FIG. 14) may provide, for at least one third node, at least a portion of the configuration information, such that the at least the portion of the configuration information is distributed to a plurality of third nodes that are associated with the second node, as described above.

Process 1100 may include additional aspects, such as any single aspect or any combination of aspects described below and/or in connection with one or more other processes described elsewhere herein.

In a first aspect, the second node is an AMF and the configuration information is AMF information.

In a second aspect, alone or in combination with the first aspect, providing the at least the portion of the configuration information comprises providing the at least the portion of the configuration information to the plurality of third nodes via a plurality of messages.

In a third aspect, alone or in combination with one or more of the first and second aspects, the at least the portion of the configuration information is provided based on at least one of a configured period of time elapsing, a receipt of a request, a detection of a network node availability, or a combination thereof.

In a fourth aspect, alone or in combination with one or more of the first through third aspects, a content of the at least the portion of the configuration information includes one or more fields identifying at least one of a core node identity, a core node availability, a core node overload condition, a configuration information validity time, or a combination thereof.

In a fifth aspect, alone or in combination with one or more of the first through fourth aspects, providing the at least the portion of the configuration information comprises providing the at least the portion of the configuration information for the at least one third node via a first message to cause the at least one third node to forward the at least the portion of the configuration information, via a second message, to one or more additional third nodes of the plurality of third nodes.

In a sixth aspect, alone or in combination with one or more of the first through fifth aspects, providing the at least the portion of the configuration information comprises providing state information, of the configuration information, for the at least one third node.

In a seventh aspect, alone or in combination with one or more of the first through sixth aspects, a message threshold is updated in connection with the configuration information, and the message threshold is configured on at least one of a per network node basis, a per endpoint basis, a per feeder link basis, a per service basis, a per message type basis, a per core node basis, or a combination thereof.

In an eighth aspect, alone or in combination with one or more of the first through seventh aspects, process 1100 includes performing reselection of the second node based on satisfaction of one or more reselection criteria for the at least one third node, such that the at least one third node is connected to the second node via the first node.

In a ninth aspect, alone or in combination with one or more of the first through eighth aspects, process 1100 includes receiving a message from the at least one third node, and providing the at least the portion of the configuration information for the second node based on receiving the message from the at least one third node.

In a tenth aspect, alone or in combination with one or more of the first through ninth aspects, process 1100 includes providing an update to the configuration information based on a difference of configuration stored in the first node relative to the second node or the third node.

In an eleventh aspect, alone or in combination with one or more of the first through tenth aspects, the configuration information includes timing information identifying a validity time for the configuration information.

In a twelfth aspect, alone or in combination with one or more of the first through eleventh aspects, the timing information includes information identifying at least one of a reference time, a time duration, an absolute time of a start to the configuration information, an absolute time of an end to the configuration information, or a combination thereof.

In a thirteenth aspect, alone or in combination with one or more of the first through twelfth aspects, providing the at least the portion of the configuration information comprises providing a node identifier for the at least one third node.

In a fourteenth aspect, alone or in combination with one or more of the first through thirteenth aspects, the configuration information includes endpoint address information, and the plurality of third nodes is associated with an endpoint address group.

In a fifteenth aspect, alone or in combination with one or more of the first through fourteenth aspects, process 1100 includes receiving a first message from the second node, wherein the first message includes a node information message or a request message, providing the first message for one or more third nodes of the plurality of third nodes, receiving a second message as a response from the one or more third nodes of the plurality of third nodes, and providing the second message for the second node.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a second node or an apparatus of a second node, in accordance with the present disclosure. Example process 1200 is an example where the apparatus or the second node (e.g., core node 170, AMF 720, AMF 820, AMF 942, network node 1010, network node 1014, or network node 1016) performs operations associated with inter-node communication.

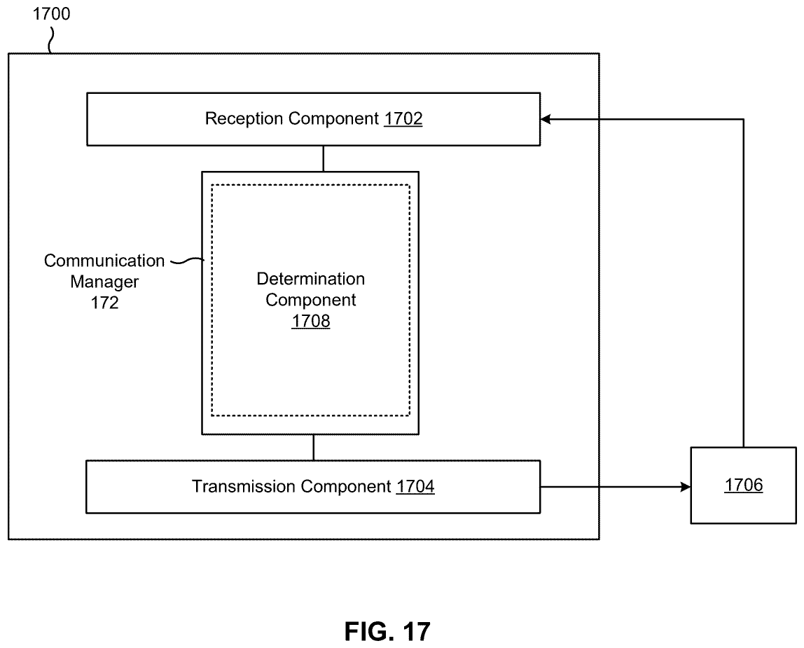

As shown in FIG. 12, in some aspects, process 1200 may include providing, to a first node, configuration information associated with a configuration of the second node, wherein at least a portion of the configuration information is provided to at least one third node via the first node and is provided for distribution to a plurality of third nodes (block 1210). For example, the second node (e.g., using communication manager 172 and/or transmission component 1704, depicted in FIG. 17) may provide, to a first node, configuration information associated with a configuration of the second node, wherein at least a portion of the configuration information is provided to at least one third node via the first node and is provided for distribution to a plurality of third nodes, as described above.

As further shown in FIG. 12, in some aspects, process 1200 may include receiving, from one or more third nodes via the second node, a configuration update based on providing the configuration information (block 1220). For example, the second node (e.g., using communication manager 172 and/or reception component 1702, depicted in FIG. 17) may receive, from one or more third nodes via the second node, a configuration update based on providing the configuration information, as described above.

Process 1200 may include additional aspects, such as any single aspect or any combination of aspects described below and/or in connection with one or more other processes described elsewhere herein.

In a first aspect, the second node is an AMF and the configuration information is AMF information.

In a second aspect, alone or in combination with the first aspect, the at least the portion of the configuration information is distributed to the plurality of third nodes via a plurality of messages.

In a third aspect, alone or in combination with one or more of the first and second aspects, the at least the portion of the configuration information is provided based on at least one of a configured period of time elapsing, a receipt of a request, a detection of a network node availability, or a combination thereof.

In a fourth aspect, alone or in combination with one or more of the first through third aspects, a content of the at least the portion of the configuration information includes one or more fields identifying at least one of a core node identity, a core node availability, a core node overload condition, a configuration information validity time, or a combination thereof.

In a fifth aspect, alone or in combination with one or more of the first through fourth aspects, the at least the portion of the configuration information is provided for the at least one third node via a first message to cause the at least one third node to forward the at least the portion of the configuration information, via a second message, to one or more additional third nodes of the plurality of third nodes.

In a sixth aspect, alone or in combination with one or more of the first through fifth aspects, the configuration information is associated with state information for the at least one third node.

In a seventh aspect, alone or in combination with one or more of the first through sixth aspects, a message threshold is updated in connection with the configuration information, and the message threshold is configured on at least one of a per network node basis, a per endpoint basis, a per feeder link basis, a per service basis, a per message type basis, a per core node basis, or a combination thereof.

In an eighth aspect, alone or in combination with one or more of the first through seventh aspects, process 1200 includes receiving at least one message associated with reselection of the second node based on satisfaction of one or more reselection criteria for the at least one third node, such that the at least one third node is connected to the second node via the first node.

In a ninth aspect, alone or in combination with one or more of the first through eighth aspects, the configuration information is associated with a node identifier for the at least one third node.

In a tenth aspect, alone or in combination with one or more of the first through ninth aspects, the configuration information includes endpoint address information, and the plurality of third nodes is associated with an endpoint address group.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a third node or an apparatus of a third node, in accordance with the present disclosure. Example process 1300 is an example where the apparatus or the third node (e.g., network node 110, network nodes 705, network nodes 805, network nodes 905 or 910, or network nodes 1010, 1014, or 1016) performs operations associated with inter-node communication.

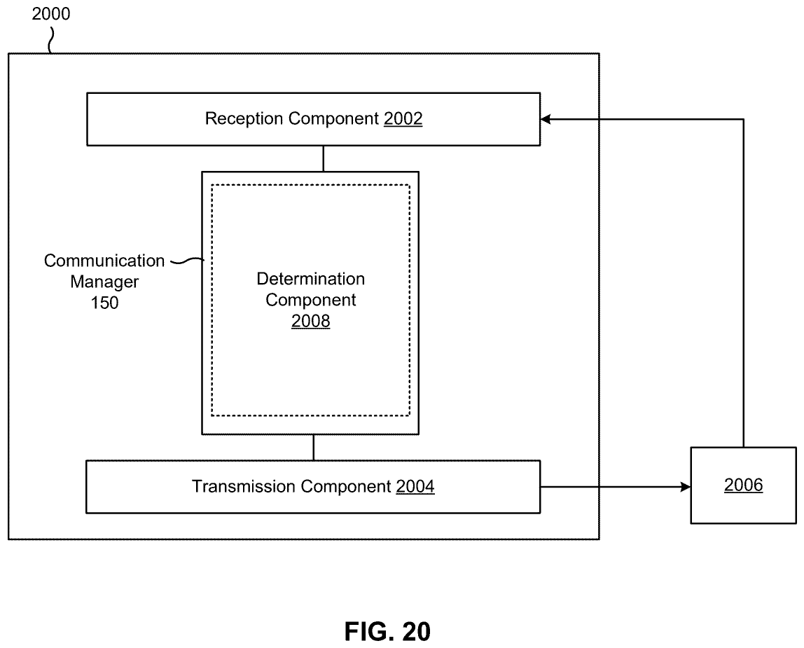

As shown in FIG. 13, in some aspects, process 1300 may include receiving, from a first node, at least a portion of configuration information associated with a configuration of a second node, wherein the at least the portion of the configuration information is distributed to a plurality of third nodes (block 1310). For example, the third node (e.g., using communication manager 150 and/or reception component 2002, depicted in FIG. 20) may receive, from a first node, at least a portion of configuration information associated with a configuration of a second node, wherein the at least the portion of the configuration information is distributed to a plurality of third nodes, as described above.

As further shown in FIG. 13, in some aspects, process 1300 may include communicating with the first node via the second node based on the receipt of the at least the portion of the configuration information (block 1320). For example, the third node (e.g., using communication manager reception component 202 and/or transmission component 2004, depicted in FIG. 20) may communicate with the first node via the second node based on the receipt of the at least the portion of the configuration information, as described above.

Process 1300 may include additional aspects, such as any single aspect or any combination of aspects described below and/or in connection with one or more other processes described elsewhere herein.

In a first aspect, the second node is an AMF and the configuration information is AMF information.

In a second aspect, alone or in combination with the first aspect, receiving the at least the portion of the configuration information comprises receiving the at least the portion of the configuration information via a first message from the first node, the plurality of third nodes receiving a plurality of second messages from the first node to convey the at least the portion of the configuration information.

In a third aspect, alone or in combination with one or more of the first and second aspects, the at least the portion of the configuration information is provided based on at least one of a configured period of time elapsing, a receipt of a request, a detection of a network node availability, or a combination thereof.

In a fourth aspect, alone or in combination with one or more of the first through third aspects, a content of the at least the portion of the configuration information includes one or more fields identifying at least one of a core node identity, a core node availability, a core node overload condition, a configuration information validity time, or a combination thereof.

In a fifth aspect, alone or in combination with one or more of the first through fourth aspects, providing the at least the portion of the configuration information comprises providing the at least the portion of the configuration information for the at least one third node via a first message, and providing the at least the portion of the configuration information, via a second message, to one or more additional third nodes of the plurality of third nodes.

In a sixth aspect, alone or in combination with one or more of the first through fifth aspects, receiving the at least the portion of the configuration information comprises receiving state information, of the configuration information, for the third node.

In a seventh aspect, alone or in combination with one or more of the first through sixth aspects, a message threshold is updated in connection with the configuration information, and the message threshold is configured on at least one of a per network node basis, a per endpoint basis, a per feeder link basis, a per service basis, a per message type basis, a per core node basis, or a combination thereof.

In an eighth aspect, alone or in combination with one or more of the first through seventh aspects, process 1300 includes communicating at least one message associated with performance of a reselection of the second node based on satisfaction of one or more reselection criteria for the third node, such that the third node is connected to the second node via the first node.

In a ninth aspect, alone or in combination with one or more of the first through eighth aspects, process 1300 includes providing a message to the first node, and receiving the at least the portion of the configuration information for the second node based on providing the message to the first node.

In a tenth aspect, alone or in combination with one or more of the first through ninth aspects, the configuration information includes timing information identifying a validity time for the configuration information.

In an eleventh aspect, alone or in combination with one or more of the first through tenth aspects, the timing information includes information identifying at least one of a reference time, a time duration, an absolute time of a start to the configuration information, an absolute time of an end to the configuration information, or a combination thereof.

In a twelfth aspect, alone or in combination with one or more of the first through eleventh aspects, receiving the at least the portion of the configuration information comprises receiving a node identifier for the third node.

In a thirteenth aspect, alone or in combination with one or more of the first through twelfth aspects, the configuration information includes endpoint address information, and the plurality of third nodes is associated with an endpoint address group.

In a fourteenth aspect, alone or in combination with one or more of the first through thirteenth aspects, process 1300 includes providing a first message to the first node, wherein the first message includes a node information message or a request message, wherein the first message is provided to the second node, receiving a second message as a response from the second node via the first node.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a first node, or a first node may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include the communication manager 162. The communication manager 162 may include a reselection component 1408 among other examples.

In some aspects, the apparatus 1400 may be configured to perform one or more operations described herein in connection with FIGS. 7A-10. Additionally, or alternatively, the apparatus 1400 may be configured to perform one or more processes described herein, such as process 1100 of FIG. 11. In some aspects, the apparatus 1400 and/or one or more components shown in FIG. 14 may include one or more components of the first node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the first node described in connection with FIG. 2.

The transmission component 1404 may transmit communications, such as reference signals, control information, data communications, or a combination thereof, to the apparatus 1406. In some aspects, one or more other components of the apparatus 1400 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, one or more modems, one or more modulators, one or more transmit MIMO processors, one or more transmit processors, one or more controllers/processors, one or more memories, or a combination thereof, of the first node described in connection with FIG. 2. In some aspects, the transmission component 1404 may be co-located with the reception component 1402 in one or more transceivers.

The reception component 1402 may receive, from a second node, configuration information associated with a configuration of the second node. The transmission component 1404 may provide, for at least one third node, at least a portion of the configuration information, such that the at least the portion of the configuration information is distributed to a plurality of third nodes that are associated with the second node.

The reselection component 1408 may perform reselection of the second node based on satisfaction of one or more reselection criteria for the at least one third node, such that the at least one third node is connected to the second node via the first node. The reception component 1402 may receive a message from the at least one third node. The transmission component 1404 may provide the at least the portion of the configuration information for the second node based on receiving the message from the at least one third node. The transmission component 1404 may provide an update to the configuration information based on a difference of configuration stored in the first node relative to the second node or the third node. The reception component 1402 may receive a first message from the second node, wherein the first message includes a node information message or a request message. The transmission component 1404 may provide the first message for one or more third nodes of the plurality of third nodes. The reception component 1402 may receive a second message as a response from the one or more third nodes of the plurality of third nodes. The transmission component 1404 may provide the second message for the second node.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

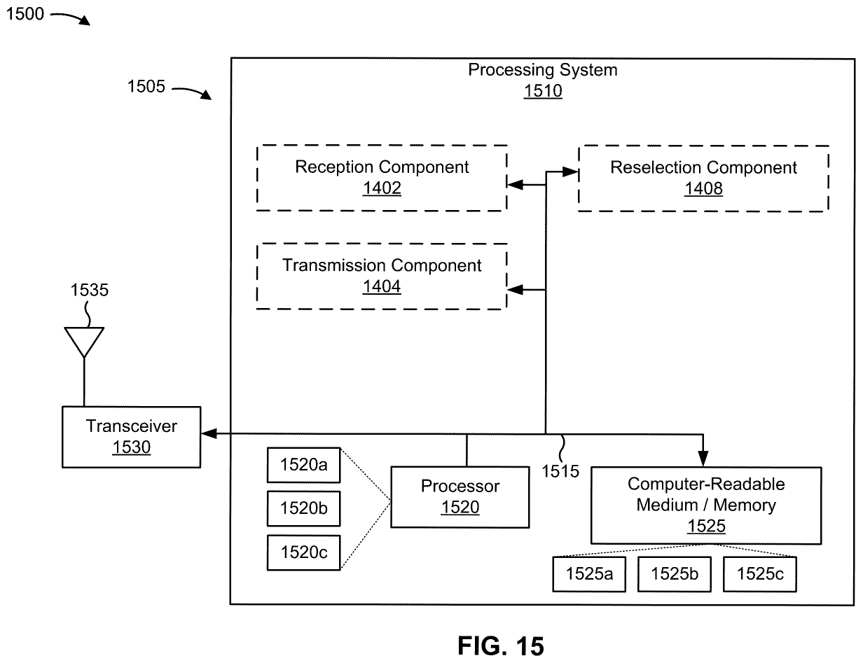

FIG. 15 is a diagram illustrating an example 1500 of a hardware implementation for an apparatus 1505 employing a processing system 1510, in accordance with the present disclosure. The apparatus 1505 may be a first node or may be at (e.g., included in) a first node.

The processing system 1510 may be implemented with a bus architecture, represented generally by the bus 1515. The bus 1515 may include any number of interconnecting buses and bridges depending on the specific application of the processing system 1510 and the overall design constraints. The bus 1515 links together various circuits including one or more processors and/or hardware components, represented by the processor 1520 (e.g., one or more processors 1520a through 1520c), the illustrated components, and the computer-readable medium/memory 1525 (e.g., one or more computer-readable media/memories 1525a through 1525c). The bus 1515 may also link various other circuits, such as timing sources, peripherals, voltage regulators, and/or power management circuits.

The processing system 1510 may be coupled to one or more transceivers 1530. A transceiver 1530 is coupled to one or more antennas 1535. The transceiver 1530 provides a means for communicating with various other apparatuses over a transmission medium. The transceiver 1530 receives a signal from the one or more antennas 1535, extracts information from the received signal, and provides the extracted information to the processing system 1510, specifically the reception component 1402. In addition, the transceiver 1530 receives information from the processing system 1510, specifically the transmission component 1404, and generates a signal to be applied to the one or more antennas 1535 based at least in part on the received information.

The processing system 1510 includes one or more processors 1520 coupled to a computer-readable medium/memory 1525. A processor 1520 is responsible for general processing, including the execution of software stored on the computer-readable medium/memory 1525. The software, when executed by the processor 1520, causes the processing system 1510 to perform the various functions described herein for any particular apparatus. The computer-readable medium/memory 1525 may also be used for storing data that is manipulated by the processor 1520 when executing software. The processing system further includes at least one of the illustrated components. The components may be software modules running in the processor 1520, resident/stored in the computer readable medium/memory 1525, one or more hardware modules coupled to the processor 1520, or some combination thereof.

In some aspects, the processing system 1510 may be a component of the proxy node 160 and may include one or more memories, such as the memory 242, and/or may include one or more processors, such as at least one of the TX MIMO processor 216, the RX processor 238, and/or the controller/processor 240. In some aspects, the apparatus 1505 for wireless communication includes means for receiving, from a second node, configuration information associated with a configuration of the second node; and means for providing, for at least one third node, at least a portion of the configuration information, such that the at least the portion of the configuration information is distributed to a plurality of third nodes that are associated with the second node. The aforementioned means may be one or more of the aforementioned components of the apparatus 1400 and/or the processing system 1510 of the apparatus 1505 configured to perform the functions recited by the aforementioned means. As described elsewhere herein, the processing system 1510 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 15 is provided as an example. Other examples may differ from what is described in connection with FIG. 15.

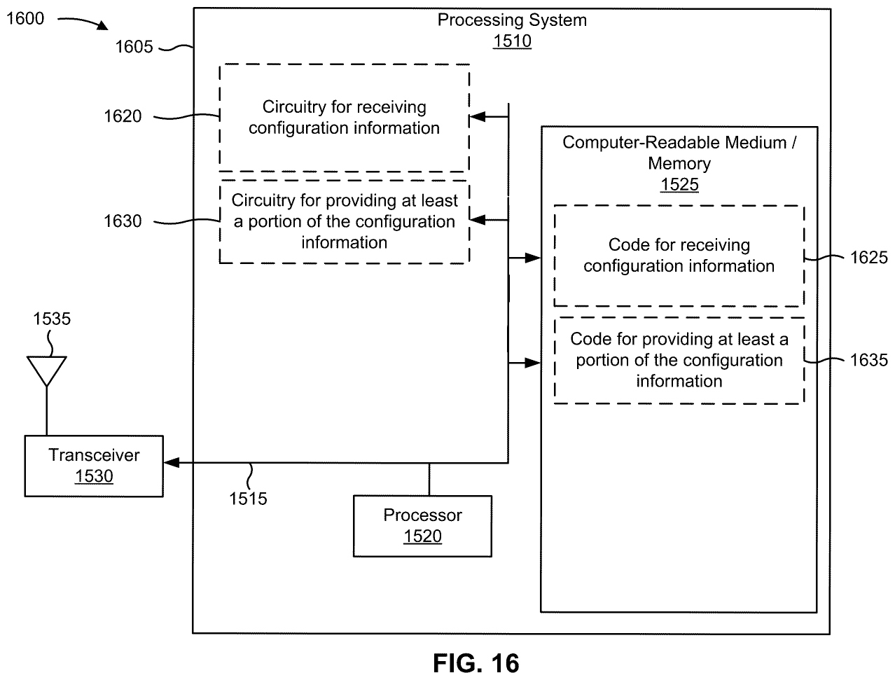

FIG. 16 is a diagram illustrating an example 1600 of an implementation of code and circuitry for an apparatus 1605, in accordance with the present disclosure. The circuitry may include processing circuitry and memory circuitry. The apparatus 1605 may be a first node, or a first node may include the apparatus 1605.

As shown in FIG. 16, the apparatus 1605 may include circuitry for receiving, from a second node, configuration information associated with a configuration of the second node (circuitry 1620). For example, the circuitry 1620 may enable the apparatus 1605 to receive, from a second node, configuration information associated with a configuration of the second node.

As shown in FIG. 16, the apparatus 1605 may include, stored in computer-readable medium 1525, code for receiving, from a second node, configuration information associated with a configuration of the second node (code 1625). For example, the code 1625, when executed by processor 1520, may cause processor 1520 to cause transceiver 1530 to receive, from a second node, configuration information associated with a configuration of the second node.

As shown in FIG. 16, the apparatus 1605 may include circuitry for providing, for at least one third node, at least a portion of the configuration information, such that the at least the portion of the configuration information is distributed to a plurality of third nodes that are associated with the second node (circuitry 1630). For example, the circuitry 1630 may enable the apparatus 1605 to provide, for at least one third node, at least a portion of the configuration information, such that the at least the portion of the configuration information is distributed to a plurality of third nodes that are associated with the second node.

As shown in FIG. 16, the apparatus 1605 may include, stored in computer-readable medium 1525, code for providing, for at least one third node, at least a portion of the configuration information, such that the at least the portion of the configuration information is distributed to a plurality of third nodes that are associated with the second node (code 1635). For example, the code 1635, when executed by processor 1520, may cause processor 1520 to cause transceiver 1530 to provide, for at least one third node, at least a portion of the configuration information, such that the at least the portion of the configuration information is distributed to a plurality of third nodes that are associated with the second node.

FIG. 16 is provided as an example. Other examples may differ from what is described in connection with FIG. 16.

FIG. 17 is a diagram of an example apparatus 1700 for wireless communication, in accordance with the present disclosure. The apparatus 1700 may be a second node, or a second node may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include the communication manager 172. The communication manager 172 may include a determination component 1708, among other examples.

In some aspects, the apparatus 1700 may be configured to perform one or more operations described herein in connection with FIGS. 7A-10. Additionally, or alternatively, the apparatus 1700 may be configured to perform one or more processes described herein, such as process 1200 of FIG. 12. In some aspects, the apparatus 1700 and/or one or more components shown in FIG. 17 may include one or more components of the second node described in connection with FIG. 2. Additionally, or alternatively, one or more components shown in FIG. 17 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1700. In some aspects, the reception component 1702 may include one or more antennas, one or more modems, one or more demodulators, one or more MIMO detectors, one or more receive processors, one or more controllers/processors, one or more memories, or a combination thereof, of the second node described in connection with FIG. 2.

The transmission component 1704 may transmit communications, such as reference signals, control information, data communications, or a combination thereof, to the apparatus 1706. In some aspects, one or more other components of the apparatus 1700 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, one or more modems, one or more modulators, one or more transmit MIMO processors, one or more transmit processors, one or more controllers/processors, one or more memories, or a combination thereof, of the second node described in connection with FIG. 2. In some aspects, the transmission component 1704 may be co-located with the reception component 1702 in one or more transceivers.

The transmission component 1704 may provide, to a first node, configuration information associated with a configuration of the second node, wherein at least a portion of the configuration information is provided to at least one third node via the first node and is provided for distribution to a plurality of third nodes. The reception component 1702 may receive, from one or more third nodes via the second node, a configuration update based on providing the configuration information. The reception component 1702 may receive at least one message associated with reselection of the second node based on satisfaction of one or more reselection criteria for the at least one third node, such that the at least one third node is connected to the second node via the first node. The determination component 1708 may determine a configuration of the apparatus 1700 or another apparatus.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

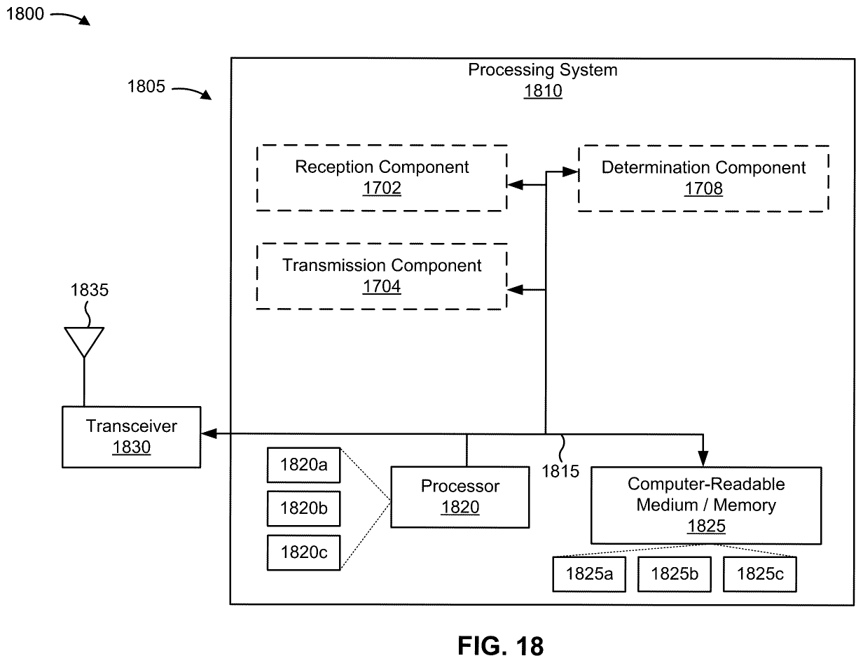

FIG. 18 is a diagram illustrating an example 1800 of a hardware implementation for an apparatus 1805 employing a processing system 1810, in accordance with the present disclosure. The apparatus 1805 may be a second node or may be at (e.g., included in) a second node.

The processing system 1810 may be implemented with a bus architecture, represented generally by the bus 1815. The bus 1815 may include any number of interconnecting buses and bridges depending on the specific application of the processing system 1810 and the overall design constraints. The bus 1815 links together various circuits including one or more processors and/or hardware components, represented by the processor 1820 (e.g., one or more processors 1820a through 1820c), the illustrated components, and the computer-readable medium/memory 1825 (e.g., one or more computer-readable media/memories 1825a through 1825c). The bus 1815 may also link various other circuits, such as timing sources, peripherals, voltage regulators, and/or power management circuits.

The processing system 1810 may be coupled to one or more transceivers 1830. A transceiver 1830 is coupled to one or more antennas 1835. The transceiver 1830 provides a means for communicating with various other apparatuses over a transmission medium. The transceiver 1830 receives a signal from the one or more antennas 1835, extracts information from the received signal, and provides the extracted information to the processing system 1810, specifically the reception component 1702. In addition, the transceiver 1830 receives information from the processing system 1810, specifically the transmission component 1704, and generates a signal to be applied to the one or more antennas 1835 based at least in part on the received information.

The processing system 1810 includes one or more processors 1820 coupled to a computer-readable medium/memory 1825. A processor 1820 is responsible for general processing, including the execution of software stored on the computer-readable medium/memory 1825. The software, when executed by the processor 1820, causes the processing system 1810 to perform the various functions described herein for any particular apparatus. The computer-readable medium/memory 1825 may also be used for storing data that is manipulated by the processor 1820 when executing software. The processing system further includes at least one of the illustrated components. The components may be software modules running in the processor 1820, resident/stored in the computer readable medium/memory 1825, one or more hardware modules coupled to the processor 1820, or some combination thereof.

In some aspects, the processing system 1810 may be a component of the core node 170 and may include one or more memories, such as the memory 242, and/or may include one or more processors, such as at least one of the TX MIMO processor 216, the RX processor 238, and/or the controller/processor 240. In some aspects, the apparatus 1805 for wireless communication includes means for providing, to a first node, configuration information associated with a configuration of the second node, wherein at least a portion of the configuration information is provided to at least one third node via the first node and is provided for distribution to a plurality of third nodes; and means for receiving, from one or more third nodes via the second node, a configuration update based on providing the configuration information. The aforementioned means may be one or more of the aforementioned components of the apparatus 1700 and/or the processing system 1810 of the apparatus 1805 configured to perform the functions recited by the aforementioned means. As described elsewhere herein, the processing system 1810 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 18 is provided as an example. Other examples may differ from what is described in connection with FIG. 18.

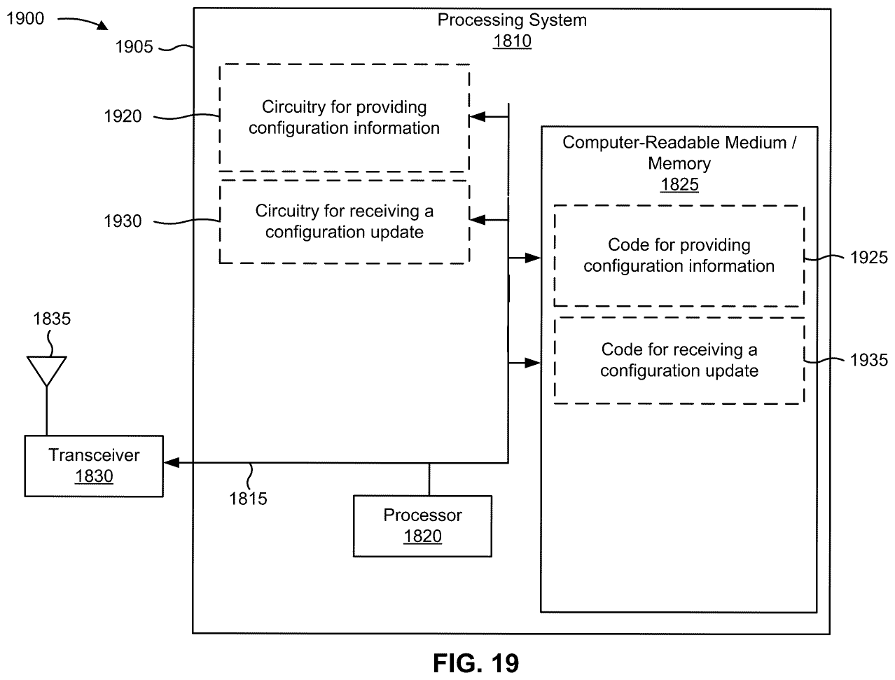

FIG. 19 is a diagram illustrating an example 1900 of an implementation of code and circuitry for an apparatus 1905, in accordance with the present disclosure. The circuitry may include processing circuitry and memory circuitry. The apparatus 1905 may be a second node, or a second node may include the apparatus 1905.

As shown in FIG. 19, the apparatus 1905 may include circuitry for providing, to a first node, configuration information associated with a configuration of the second node, wherein at least a portion of the configuration information is provided to at least one third node via the first node and is provided for distribution to a plurality of third nodes (circuitry 1920). For example, the circuitry 1920 may enable the apparatus 1905 to provide, to a first node, configuration information associated with a configuration of the second node, wherein at least a portion of the configuration information is provided to at least one third node via the first node and is provided for distribution to a plurality of third nodes.

As shown in FIG. 19, the apparatus 1905 may include, stored in computer-readable medium 1825, code for providing, to a first node, configuration information associated with a configuration of the second node, wherein at least a portion of the configuration information is provided to at least one third node via the first node and is provided for distribution to a plurality of third nodes (code 1925). For example, the code 1925, when executed by processor 1820, may cause processor 1820 to cause transceiver 1830 to provide, to a first node, configuration information associated with a configuration of the second node, wherein at least a portion of the configuration information is provided to at least one third node via the first node and is provided for distribution to a plurality of third nodes.

As shown in FIG. 19, the apparatus 1905 may include circuitry for receiving, from one or more third nodes via the second node, a configuration update based on providing the configuration information (circuitry 1930). For example, the circuitry 1930 may enable the apparatus 1905 to receive, from one or more third nodes via the second node, a configuration update based on providing the configuration information.

As shown in FIG. 19, the apparatus 1905 may include, stored in computer-readable medium 1825, code for receiving, from one or more third nodes via the second node, a configuration update based on providing the configuration information (code 1935). For example, the code 1935, when executed by processor 1820, may cause processor 1820 to cause transceiver 1830 to receive, from one or more third nodes via the second node, a configuration update based on providing the configuration information.

FIG. 19 is provided as an example. Other examples may differ from what is described in connection with FIG. 19.

FIG. 20 is a diagram of an example apparatus 2000 for wireless communication, in accordance with the present disclosure. The apparatus 2000 may be a third node, or a third node may include the apparatus 2000. In some aspects, the apparatus 2000 includes a reception component 2002 and a transmission component 2004, which may be in communication with one another (for example, via one or more buses and/or one or more other components). As shown, the apparatus 2000 may communicate with another apparatus 2006 (such as a UE, a base station, or another wireless communication device) using the reception component 2002 and the transmission component 2004. As further shown, the apparatus 2000 may include the communication manager 150. The communication manager 150 may include a determination component 2008, among other examples.

In some aspects, the apparatus 2000 may be configured to perform one or more operations described herein in connection with FIGS. 7A-10. Additionally, or alternatively, the apparatus 2000 may be configured to perform one or more processes described herein, such as process 1300 of FIG. 13. In some aspects, the apparatus 2000 and/or one or more components shown in FIG. 20 may include one or more components of the third node described in connection with FIG. 2. Additionally, or alternatively, one or more components shown in FIG. 20 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2002 may receive communications, such as reference signals, control information, data communications, or a combination thereof, from the apparatus 2006. The reception component 2002 may provide received communications to one or more other components of the apparatus 2000. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2000. In some aspects, the reception component 2002 may include one or more antennas, one or more modems, one or more demodulators, one or more MIMO detectors, one or more receive processors, one or more controllers/processors, one or more memories, or a combination thereof, of the third node described in connection with FIG. 2.

The transmission component 2004 may transmit communications, such as reference signals, control information, data communications, or a combination thereof, to the apparatus 2006. In some aspects, one or more other components of the apparatus 2000 may generate communications and may provide the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, one or more modems, one or more modulators, one or more transmit MIMO processors, one or more transmit processors, one or more controllers/processors, one or more memories, or a combination thereof, of the third node described in connection with FIG. 2. In some aspects, the transmission component 2004 may be co-located with the reception component 2002 in one or more transceivers.

The reception component 2002 may receive, from a first node, at least a portion of configuration information associated with a configuration of a second node, wherein the at least the portion of the configuration information is distributed to a plurality of third nodes. The transmission component 2004 and/or the reception component 2002 may communicate with the first node via the second node based on the receipt of the at least the portion of the configuration information. The transmission component 2004 and/or the reception component 2002 may communicate at least one message associated with performance of a reselection of the second node based on satisfaction of one or more reselection criteria for the third node, such that the third node is connected to the second node via the first node. The determination component 2008 may determine a configuration of another node.

The transmission component 2004 may provide a message to the first node. The reception component 2002 may receive the at least the portion of the configuration information for the second node based on providing the message to the first node. The transmission component 2004 may provide a first message to the first node, wherein the first message includes a node information message or a request message, and wherein the first message is provided to the second node. The reception component 2002 may receive a second message as a response from the second node via the first node.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

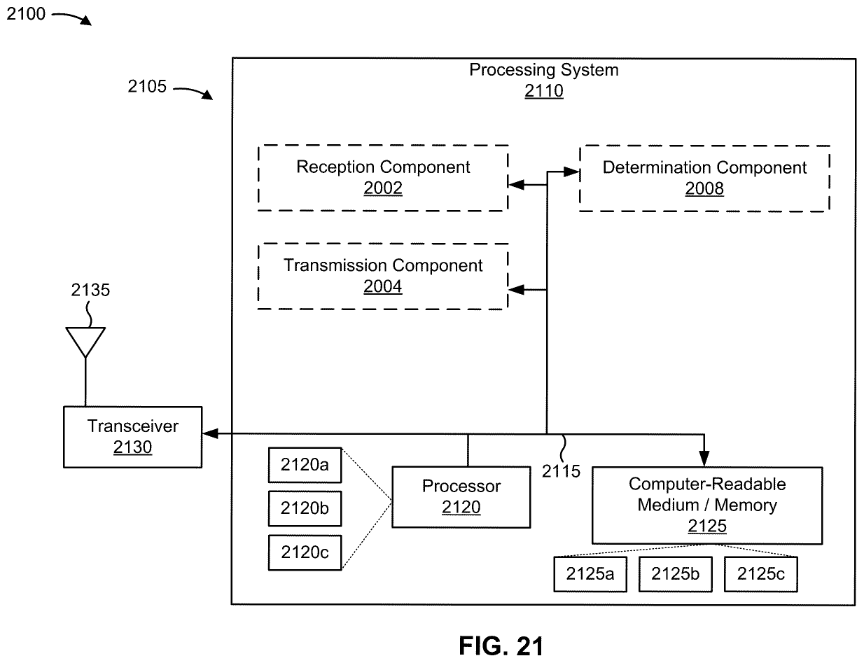

FIG. 21 is a diagram illustrating an example 2100 of a hardware implementation for an apparatus 2105 employing a processing system 2110, in accordance with the present disclosure. The apparatus 2105 may be a third node or may be at (e.g., included in) a third node.

The processing system 2110 may be implemented with a bus architecture, represented generally by the bus 2115. The bus 2115 may include any number of interconnecting buses and bridges depending on the specific application of the processing system 2110 and the overall design constraints. The bus 2115 links together various circuits including one or more processors and/or hardware components, represented by the processor 2120 (e.g., one or more processors 2120a through 2120c), the illustrated components, and the computer-readable medium/memory 2125 (e.g., one or more computer-readable media/memories 2125a through 2125c). The bus 2115 may also link various other circuits, such as timing sources, peripherals, voltage regulators, and/or power management circuits.

The processing system 2110 may be coupled to one or more transceivers 2130. A transceiver 2130 is coupled to one or more antennas 2135. The transceiver 2130 provides a means for communicating with various other apparatuses over a transmission medium. The transceiver 2130 receives a signal from the one or more antennas 2135, extracts information from the received signal, and provides the extracted information to the processing system 2110, specifically the reception component 2002. In addition, the transceiver 2130 receives information from the processing system 2110, specifically the transmission component 2004, and generates a signal to be applied to the one or more antennas 2135 based at least in part on the received information.

The processing system 2110 includes one or more processors 2120 coupled to a computer-readable medium/memory 2125. A processor 2120 is responsible for general processing, including the execution of software stored on the computer-readable medium/memory 2125. The software, when executed by the processor 2120, causes the processing system 2110 to perform the various functions described herein for any particular apparatus. The computer-readable medium/memory 2125 may also be used for storing data that is manipulated by the processor 2120 when executing software. The processing system further includes at least one of the illustrated components. The components may be software modules running in the processor 2120, resident/stored in the computer readable medium/memory 2125, one or more hardware modules coupled to the processor 2120, or some combination thereof.

In some aspects, the processing system 2110 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 2105 for wireless communication includes means for receiving, from a first node, at least a portion of configuration information associated with a configuration of a second node, wherein the at least the portion of the configuration information is distributed to a plurality of third nodes; and means for communicating with the first node via the second node based on the receipt of the at least the portion of the configuration information. The aforementioned means may be one or more of the aforementioned components of the apparatus 2000 and/or the processing system 2110 of the apparatus 2105 configured to perform the functions recited by the aforementioned means. As described elsewhere herein, the processing system 2110 may include the TX MIMO processor 216, the receive processor 238, and/or the controller/processor 240. In one configuration, the aforementioned means may be the TX MIMO processor 216, the receive processor 238, and/or the controller/processor 240 configured to perform the functions and/or operations recited herein.

FIG. 21 is provided as an example. Other examples may differ from what is described in connection with FIG. 21.

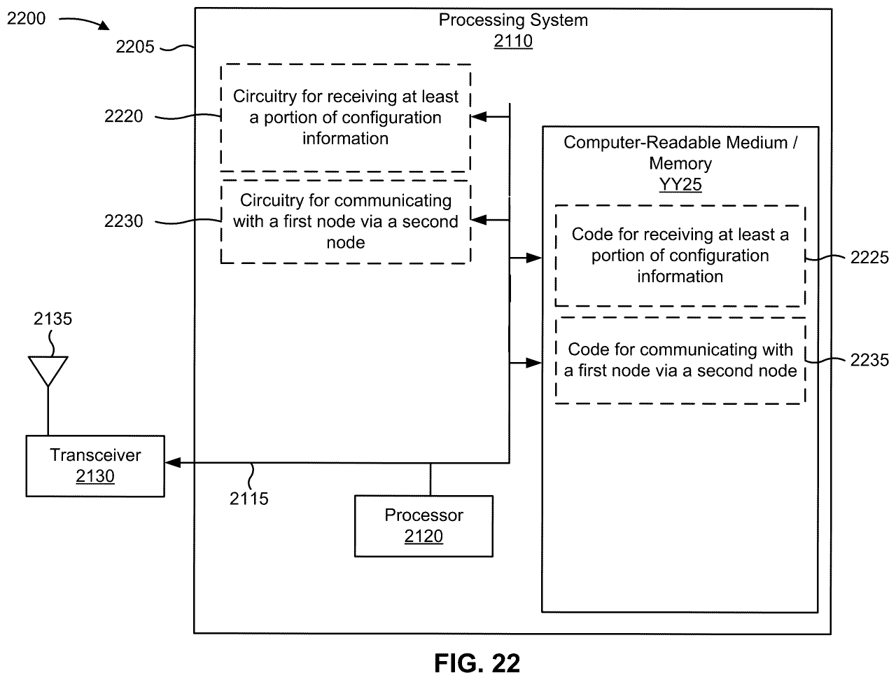

FIG. 22 is a diagram illustrating an example 2200 of an implementation of code and circuitry for an apparatus 2205, in accordance with the present disclosure. The circuitry may include processing circuitry and memory circuitry. The apparatus 2205 may be a third node, or a third node may include the apparatus 2205.

As shown in FIG. 22, the apparatus 2205 may include circuitry for receiving, from a first node, at least a portion of configuration information associated with a configuration of a second node, wherein the at least the portion of the configuration information is distributed to a plurality of third nodes (circuitry 2220). For example, the circuitry 2220 may enable the apparatus 2205 to receive, from a first node, at least a portion of configuration information associated with a configuration of a second node, wherein the at least the portion of the configuration information is distributed to a plurality of third nodes.

As shown in FIG. 22, the apparatus 2205 may include, stored in computer-readable medium 2125, code for receiving, from a first node, at least a portion of configuration information associated with a configuration of a second node, wherein the at least the portion of the configuration information is distributed to a plurality of third nodes (code 2225). For example, the code 2225, when executed by processor 2120, may cause processor 2120 to cause transceiver 2130 to receive, from a first node, at least a portion of configuration information associated with a configuration of a second node, wherein the at least the portion of the configuration information is distributed to a plurality of third nodes.

As shown in FIG. 22, the apparatus 2205 may include circuitry for communicating with the first node via the second node based on the receipt of the at least the portion of the configuration information (circuitry 2230). For example, the circuitry 2230 may enable the apparatus 2205 to communicate with the first node via the second node based on the receipt of the at least the portion of the configuration information.

As shown in FIG. 22, the apparatus 2205 may include, stored in computer-readable medium 2125, code for communicating with the first node via the second node based on the receipt of the at least the portion of the configuration information (code 2235). For example, the code 2235, when executed by processor 2120, may cause processor 2120 to cause transceiver 2130 to communicate with the first node via the second node based on the receipt of the at least the portion of the configuration information.

FIG. 22 is provided as an example. Other examples may differ from what is described in connection with FIG. 22.

The following provides an overview of some Aspects of the present disclosure:

Aspect 1: A method of wireless communication performed at a first node, comprising: receiving, from a second node, configuration information associated with a configuration of the second node; and providing, for at least one third node, at least a portion of the configuration information, such that the at least the portion of the configuration information is distributed to a plurality of third nodes that are associated with the second node.

Aspect 2: The method of Aspect 1, wherein the second node is an access and mobility management function (AMF) and the configuration information is AMF information.

Aspect 3: The method of any of Aspects 1-2, wherein providing the at least the portion of the configuration information comprises: providing the at least the portion of the configuration information to the plurality of third nodes via a plurality of messages.

Aspect 4: The method of any of Aspects 1-3, wherein the at least the portion of the configuration information is provided based on at least one of: a configured period of time elapsing, a receipt of a request, a detection of a network node availability, or a combination thereof.

Aspect 5: The method of any of Aspects 1-4, wherein a content of the at least the portion of the configuration information includes one or more fields identifying at least one of: a core node identity, a core node availability, a core node overload condition, a configuration information validity time, or a combination thereof.

Aspect 6: The method of any of Aspects 1-5, wherein providing the at least the portion of the configuration information comprises: providing the at least the portion of the configuration information for the at least one third node via a first message to cause the at least one third node to forward the at least the portion of the configuration information, via a second message, to one or more additional third nodes of the plurality of third nodes.

Aspect 7: The method of any of Aspects 1-6, wherein providing the at least the portion of the configuration information comprises: providing state information, of the configuration information, for the at least one third node.

Aspect 8: The method of any of Aspects 1-7, wherein a message threshold is updated in connection with the configuration information, and wherein the message threshold is configured on at least one of: a per network node basis, a per endpoint basis, a per feeder link basis, a per service basis, a per message type basis, a per core node basis, or a combination thereof.

Aspect 9: The method of any of Aspects 1-8, further comprising: performing reselection of the second node based on satisfaction of one or more reselection criteria for the at least one third node, such that the at least one third node is connected to the second node via the first node.

Aspect 10: The method of any of Aspects 1-9, further comprising: receiving a message from the at least one third node; and providing the at least the portion of the configuration information for the second node based on receiving the message from the at least one third node.

Aspect 11: The method of Aspect 10, further comprising: providing an update to the configuration information based a difference of configuration stored in the first node relative to the second node or the third node.

Aspect 12: The method of Aspect 10, wherein the configuration information includes timing information identifying a validity time for the configuration information.

Aspect 13: The method of Aspect 12, wherein the timing information includes information identifying at least one of: a reference time, a time duration, an absolute time of a start to the configuration information, an absolute time of an end to the configuration information, or a combination thereof.

Aspect 14: The method of any of Aspects 1-13, wherein providing the at least the portion of the configuration information comprises: providing a node identifier for the at least one third node.

Aspect 15: The method of any of Aspects 1-14, wherein the configuration information includes endpoint address information, and wherein the plurality of third nodes is associated with an endpoint address group.

Aspect 16: The method of any of Aspects 1-15, further comprising: receiving a first message from the second node, wherein the first message includes a node information message or a request message; providing the first message for one or more third nodes of the plurality of third nodes; receiving a second message as a response from the one or more third nodes of the plurality of third nodes; and providing the second message for the second node.

Aspect 17: A method of wireless communication performed by a second node, comprising: providing, to a first node, configuration information associated with a configuration of the second node, wherein at least a portion of the configuration information is provided to at least one third node via the first node and is provided for distribution to a plurality of third nodes; and receiving, from one or more third nodes via the second node, a configuration update based on providing the configuration information.

Aspect 18: The method of Aspect 17, wherein the second node is an access and mobility management function (AMF) and the configuration information is AMF information.

Aspect 19: The method of any of Aspects 17-18, wherein the at least the portion of the configuration information is distributed to the plurality of third nodes via a plurality of messages.

Aspect 20: The method of any of Aspects 17-19, wherein the at least the portion of the configuration information is provided based on at least one of: a configured period of time elapsing, a receipt of a request, a detection of a network node availability, or a combination thereof.

Aspect 21: The method of any of Aspects 17-20, wherein a content of the at least the portion of the configuration information includes one or more fields identifying at least one of: a core node identity, a core node availability, a core node overload condition, a configuration information validity time, or a combination thereof.

Aspect 22: The method of any of Aspects 17-21, wherein the at least the portion of the configuration information is provided for the at least one third node via a first message to cause the at least one third node to forward the at least the portion of the configuration information, via a second message, to one or more additional third nodes of the plurality of third nodes.

Aspect 23: The method of any of Aspects 17-22, wherein the configuration information is associated with state information for the at least one third node.

Aspect 24: The method of any of Aspects 17-23, wherein a message threshold is updated in connection with the configuration information, and wherein the message threshold is configured on at least one of: a per network node basis, a per endpoint basis, a per feeder link basis, a per service basis, a per message type basis, a per core node basis, or a combination thereof.

Aspect 25: The method of any of Aspects 17-24, further comprising: receiving at least one message associated with reselection of the second node based on satisfaction of one or more reselection criteria for the at least one third node, such that the at least one third node is connected to the second node via the first node.

Aspect 26: The method of any of Aspects 17-25, wherein the configuration information is associated with a node identifier for the at least one third node.

Aspect 27: The method of any of Aspects 17-26, wherein the configuration information includes endpoint address information, and wherein the plurality of third nodes is associated with an endpoint address group.

Aspect 28: A method of wireless communication performed by a third node, comprising: receiving, from a first node, at least a portion of configuration information associated with a configuration of a second node, wherein the at least the portion of the configuration information is distributed to a plurality of third nodes; and communicating with the first node via the second node based on the receipt of the at least the portion of the configuration information.

Aspect 29: The method of Aspect 28, wherein the second node is an access and mobility management function (AMF) and the configuration information is AMF information.

Aspect 30: The method of any of Aspects 28-29, wherein receiving the at least the portion of the configuration information comprises: receiving the at least the portion of the configuration information via a first message from the first node, the plurality of third nodes receiving a plurality of second messages from the first node to convey the at least the portion of the configuration information.

Aspect 31: The method of any of Aspects 28-30, wherein the at least the portion of the configuration information is provided based on at least one of: a configured period of time elapsing, a receipt of a request, a detection of a network node availability, or a combination thereof.

Aspect 32: The method of any of Aspects 28-31, wherein a content of the at least the portion of the configuration information includes one or more fields identifying at least one of: a core node identity, a core node availability, a core node overload condition, a configuration information validity time, or a combination thereof.

Aspect 33: The method of any of Aspects 28-32, wherein providing the at least the portion of the configuration information comprises: providing the at least the portion of the configuration information for the at least one third node via a first message; and providing the at least the portion of the configuration information, via a second message, to one or more additional third nodes of the plurality of third nodes.

Aspect 34: The method of any of Aspects 28-33, wherein receiving the at least the portion of the configuration information comprises: receiving state information, of the configuration information, for the third node.

Aspect 35: The method of any of Aspects 28-34, wherein a message threshold is updated in connection with the configuration information, and wherein the message threshold is configured on at least one of: a per network node basis, a per endpoint basis, a per feeder link basis, a per service basis, a per message type basis, a per core node basis, or a combination thereof.

Aspect 36: The method of any of Aspects 28-35, further comprising: communicating at least one message associated with performance of a reselection of the second node based on satisfaction of one or more reselection criteria for the third node, such that the third node is connected to the second node via the first node.

Aspect 37: The method of any of Aspects 28-36, further comprising: providing a message to the first node; and receiving the at least the portion of the configuration information for the second node based on providing the message to the first node.

Aspect 38: The method of Aspect 37, wherein the configuration information includes timing information identifying a validity time for the configuration information.

Aspect 39: The method of Aspect 38, wherein the timing information includes information identifying at least one of: a reference time, a time duration, an absolute time of a start to the configuration information, an absolute time of an end to the configuration information, or a combination thereof.

Aspect 40: The method of any of Aspects 28-39, wherein receiving the at least the portion of the configuration information comprises: receiving a node identifier for the third node.

Aspect 41: The method of any of Aspects 28-40, wherein the configuration information includes endpoint address information, and wherein the plurality of third nodes is associated with an endpoint address group.

Aspect 42: The method of any of Aspects 28-41, further comprising: providing a first message to the first node, wherein the first message includes a node information message or a request message, wherein the first message is provided to the second node; receiving a second message as a response from the second node via the first node.

Aspect 43: An apparatus for wireless communication at a first node, comprising: one or more memories; and one or more processors coupled to the one or more memories, the one or more processors configured to cause the first node to: receive, from a second node, configuration information associated with a configuration of the second node; and provide, for at least one third node, at least a portion of the configuration information, such that the at least the portion of the configuration information is distributed to a plurality of third nodes that are associated with the second node.

Aspect 44: The apparatus of Aspect 43, wherein the one or more processors are configured, individually or collectively, to cause the first node to: receive, from a second node, configuration information associated with a configuration of the second node; and provide, for at least one third node, at least a portion of the configuration information, such that the at least the portion of the configuration information is distributed to a plurality of third nodes that are associated with the second node.

Aspect 45: An apparatus for wireless communication at a second node, comprising: one or more memories; and one or more processors coupled to the one or more memories, the one or more processors configured to cause the second node to: provide, to a first node, configuration information associated with a configuration of the second node, wherein at least a portion of the configuration information is provided to at least one third node via the first node and is provided for distribution to a plurality of third nodes; and receive, from one or more third nodes via the second node, a configuration update based on providing the configuration information.

Aspect 46: The apparatus of Aspect 45, wherein the one or more processors are configured, individually or collectively, to cause the second node to: provide, to a first node, configuration information associated with a configuration of the second node, wherein at least a portion of the configuration information is provided to at least one third node via the first node and is provided for distribution to a plurality of third nodes; and receive, from one or more third nodes via the second node, a configuration update based on providing the configuration information.

Aspect 47: An apparatus for wireless communication at a third node, comprising: one or more memories; and one or more processors coupled to the one or more memories, the one or more processors configured to cause the third node to: receive, from a first node, at least a portion of configuration information associated with a configuration of a second node, wherein the at least the portion of the configuration information is distributed to a plurality of third nodes; and communicate with the first node via the second node based on the receipt of the at least the portion of the configuration information.

Aspect 49: The apparatus of Aspect 47, wherein the one or more processors are configured, individually or collectively, to cause the second node to: receive, from a first node, at least a portion of configuration information associated with a configuration of a second node, wherein the at least the portion of the configuration information is distributed to a plurality of third nodes; and communicate with the first node via the second node based on the receipt of the at least the portion of the configuration information.

Aspect 50: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-49.

Aspect 51: An apparatus for wireless communication at a device, the apparatus comprising one or more memories and one or more processors coupled to the one or more memories, the one or more processors configured to cause the device to perform the method of one or more of Aspects 1-49.

Aspect 52: An apparatus for wireless communication, the apparatus comprising at least one means for performing the method of one or more of Aspects 1-49.

Aspect 53: A non-transitory computer-readable medium storing code for wireless communication, the code comprising instructions executable by one or more processors to perform the method of one or more of Aspects 1-49.

Aspect 54: A non-transitory computer-readable medium storing a set of instructions for wireless communication, the set of instructions comprising one or more instructions that, when executed by one or more processors of a device, cause the device to perform the method of one or more of Aspects 1-49.

Aspect 55: A device for wireless communication, the device comprising a processing system that includes one or more processors and one or more memories coupled with the one or more processors, the processing system configured to cause the device to perform the method of one or more of Aspects 1-49.

Aspect 56: An apparatus for wireless communication at a device, the apparatus comprising one or more memories and one or more processors coupled to the one or more memories, the one or more processors individually or collectively configured to cause the device to perform the method of one or more of Aspects 1-49.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first node, comprising:
one or more memories; and
one or more processors coupled with the one or more memories and configured to cause the first node to:
receive, from a second node, configuration information associated with a configuration of the second node; and
provide, for at least one third node, at least a portion of the configuration information, such that the at least the portion of the configuration information is distributed to a plurality of third nodes that are associated with the second node.

2. The first node of claim 1, wherein the second node is an access and mobility management function (AMF) and the configuration information is AMF information.

3. The first node of claim 1, wherein the one or more processors, to cause the first node to provide the at least the portion of the configuration information, are configured to:
provide the at least the portion of the configuration information to the plurality of third nodes via a plurality of messages.

4. The first node of claim 1, wherein the at least the portion of the configuration information is provided based on at least one of:
a configured period of time elapsing,
a receipt of a request,
a detection of a network node availability, or
a combination thereof.

5. The first node of claim 1, wherein a content of the at least the portion of the configuration information includes one or more fields identifying at least one of:
a core node identity,
a core node availability,
a core node overload condition,
a configuration information validity time, or
a combination thereof.

6. The first node of claim 1, wherein the one or more processors, to cause the first node to provide the at least the portion of the configuration information, are configured to:
provide the at least the portion of the configuration information for the at least one third node via a first message to cause the at least one third node to forward the at least the portion of the configuration information, via a second message, to one or more additional third nodes of the plurality of third nodes.

7. The first node of claim 1, wherein the one or more processors, to cause the first node to provide the at least the portion of the configuration information, are configured to:
provide state information, of the configuration information, for the at least one third node.

8. The first node of claim 1, wherein a message threshold is updated in connection with the configuration information, and
wherein the message threshold is configured on at least one of:
a per network node basis,
a per endpoint basis,
a per feeder link basis,
a per service basis,
a per message type basis,
a per core node basis,
a combination thereof.

9. The first node of claim 1, wherein the one or more processors are further configured to:
perform reselection of the second node based on satisfaction of one or more reselection criteria for the at least one third node, such that the at least one third node is connected to the second node via the first node.

10. The first node of claim 1, wherein the one or more processors are further configured to:
receive a message from the at least one third node; and
provide the at least the portion of the configuration information for the second node based on receiving the message from the at least one third node.

11. The first node of claim 10, wherein the one or more processors are further configured to:
provide an update to the configuration information based a difference of configuration stored in the first node relative to the second node or the third node.

12. The first node of claim 10, wherein the configuration information includes timing information identifying a validity time for the configuration information.

13. The first node of claim 12, wherein the timing information includes information identifying at least one of:
a reference time,
a time duration,
an absolute time of a start to the configuration information,
an absolute time of an end to the configuration information, or
a combination thereof.

14. The first node of claim 1, wherein the one or more processors, to cause the first node to provide the at least the portion of the configuration information, are configured to:
provide a node identifier for the at least one third node.

15. The first node of claim 1, wherein the configuration information includes endpoint address information, and wherein the plurality of third nodes is associated with an endpoint address group.

16. The first node of claim 1, wherein the one or more processors are further configured to:
receive a first message from the second node, wherein the first message includes a node information message or a request message;
provide the first message for one or more third nodes of the plurality of third nodes;
receive a second message as a response from the one or more third nodes of the plurality of third nodes; and
provide the second message for the second node.

17. An apparatus for wireless communication at a second node, comprising:
one or more memories; and
one or more processors coupled with the one or more memories and configured to cause the second node to:
provide, to a first node, configuration information associated with a configuration of the second node, wherein at least a portion of the configuration information is provided to at least one third node via the first node and is provided for distribution to a plurality of third nodes; and
receive, from one or more third nodes via the second node, a configuration update based on providing the configuration information.

18. The second node of claim 17, wherein the second node is an access and mobility management function (AMF) and the configuration information is AMF information.

19. The second node of claim 17, wherein the at least the portion of the configuration information is distributed to the plurality of third nodes via a plurality of messages.

20. An apparatus for wireless communication at a third node, comprising:
one or more memories; and
one or more processors coupled with the one or more memories and configured to cause the third node to:
receive, from a first node, at least a portion of configuration information associated with a configuration of a second node, wherein the at least the portion of the configuration information is distributed to a plurality of third nodes; and
communicate with the first node via the second node based on receipt of the at least the portion of the configuration information.
